(19) United States
(12) Patent Application Publication
(10) Pub. No.: US 2021/0155215 A1
(43) Pub. Date: May 27, 2021

(54) VEHICLE BRAKE SYSTEM WITH SECONDARY BRAKE MODULE

(71) Applicant: ZF Active Safety US Inc., Livonia, MI (US)

(72) Inventor: Blaise Ganzel, Ann Arbor, MI (US)

(73) Assignee: ZF Active Safety US Inc., Livonia, MI (US)

(21) Appl. No.: 17/045,405

(22) PCT Filed: Apr. 4, 2019
(86) PCT No.: PCT/US2019/025773

§ 371 Date: Oct. 5, 2020

Related U.S. Application Data
(60) Provisional application No. 62/652,498, filed on Apr. 4, 2018.

(51) Int. Cl. B60T 13/62; B60T 13/14; B60T 11/20; B60T 8/17; B60T 7/04; B60T 13/68; B60T 13/74; B60T 17/04; B60T 8/32

(52) U.S. Cl. CPC B60T 13/62; B60T 13/145; B60T 11/20; B60T 8/17; B60T 7/042; B60T 13/686; B60T 15/028; B60T 17/04; B60T 8/326; B60T 2270/402; B60T 2270/404; B60T 2270/82; B60T 13/745

(57) ABSTRACT

A brake system has a wheel brake and is operable under a non-failure normal braking mode and a manual push-through mode. The system includes a master cylinder operable by a brake pedal during a manual push-through mode to provide fluid flow at an output for actuating the wheel brake. A first source of pressurized fluid provides fluid pressure for actuating the wheel brake under a normal braking mode. A second source of pressurized fluid generates brake actuating pressure for actuating the wheel brake under the manual push-through mode.

### CROSS-REFERENCE TO RELATED APPLICATIONS

This application is a national stage of International Application No. PCT/US19/025773, filed Apr. 4, 2019, the disclosure of which is incorporated herein by reference in its entirety, and which claimed priority to U.S. Patent Application No. 62/652,498, filed Apr. 4, 2018, the disclosure of which is incorporated herein by reference in its entirety.

### TECHNICAL FIELD

The present disclosure relates in general to vehicle braking systems. Vehicles are commonly slowed and stopped with hydraulic brake systems.

### BACKGROUND

These systems vary in complexity but a base brake system typically includes a brake pedal, a tandem master cylinder, fluid conduits arranged in two similar but separate brake circuits, and wheel brakes in each circuit. The driver of the vehicle operates a brake pedal which is connected to the master cylinder. When the brake pedal is depressed, the master cylinder generates hydraulic forces in both brake circuits by pressurizing brake fluid. The pressurized fluid travels through the fluid conduit in both circuits to actuate brake cylinders at the wheels to slow the vehicle.

Base brake systems typically use a brake booster which provides a force to the master cylinder which assists the pedal force created by the driver. The booster can be vacuum or hydraulically operated. A typical hydraulic booster generates pressurized fluid for assisting in pressurizing the wheel brakes, thereby increasing the pressures generated by the master cylinder. Hydraulic boosters are commonly located adjacent the master cylinder and use a boost valve to help control the pressurized fluid.

Braking a vehicle in a controlled manner under adverse conditions requires precise application of the brakes by the driver. Under these conditions, a driver can easily apply excessive braking pressure thus causing one or more wheels to lock, resulting in excessive slippage between the wheel and road surface. Such wheel lock-up conditions can lead to greater stopping distances and possible loss of directional control.

Advances in braking technology have led to the introduction of Anti-lock Braking Systems (ABS). An ABS system monitors wheel rotational behavior and selectively applies and relieves brake pressure in the corresponding wheel brakes in order to maintain the wheel speed within a selected slip range to achieve maximum braking force. While such systems are typically adapted to control the braking of each braked wheel of the vehicle, some systems have been developed for controlling the braking of only a portion of the plurality of braked wheels.

Electronically controlled ABS valves, comprising apply valves and dump valves, are located between the master cylinder and the wheel brakes. The ABS valves regulate the pressure between the master cylinder and the wheel brakes. Typically, when activated, these ABS valves operate in three pressure control modes: pressure apply, pressure dump and pressure hold. The apply valves allow pressurized brake fluid into respective ones of the wheel brakes to increase pressure during the apply mode, and the dump valves relieve brake fluid from their associated wheel brakes during the dump mode. Wheel brake pressure is held constant during the hold mode by closing both the apply valves and the dump valves.

To achieve maximum braking forces while maintaining vehicle stability, it is desirable to achieve optimum slip levels at the wheels of both the front and rear axles. During vehicle deceleration different braking forces are required at the front and rear axles to reach the desired slip levels. Therefore, the brake pressures should be proportioned between the front and rear brakes to achieve the highest braking forces at each axle. ABS systems with such ability, known as Dynamic Rear Proportioning (DRP) systems, use the ABS valves to separately control the braking pressures on the front and rear wheels to dynamically achieve optimum braking performance at the front and rear axles under the then current conditions.

A further development in braking technology has led to the introduction of Traction Control (TC) systems. Typically, valves have been added to existing ABS systems to provide a brake system which controls wheel speed during acceleration. Excessive wheel speed during vehicle acceleration leads to wheel slippage and a loss of traction. An electronic control system senses this condition and automatically applies braking pressure to the wheel cylinders of the slipping wheel to reduce the slippage and increase the traction available. In order to achieve optimal vehicle acceleration, pressurized brake fluid is made available to the wheel cylinders even if the master cylinder is not actuated by the driver.

During vehicle motion such as cornering, dynamic forces are generated which can reduce vehicle stability. A Vehicle Stability Control (VSC) brake system improves the stability of the vehicle by counteracting these forces through selective brake actuation. These forces and other vehicle parameters are detected by sensors which signal an electronic control unit. The electronic control unit automatically operates pressure control devices to regulate the amount of hydraulic pressure applied to specific individual wheel brakes. In order to achieve optimal vehicle stability, braking pressures greater than the master cylinder pressure must quickly be available at all times.

Brake systems may also be used for regenerative braking to recapture energy. An electromagnetic force of an electric motor/generator is used in regenerative braking for providing a portion of the braking torque to the vehicle to meet the braking needs of the vehicle. A control module in the brake system communicates with a powertrain control module to provide coordinated braking during regenerative braking as well as braking for wheel lock and skid conditions. For example, as the operator of the vehicle begins to brake during regenerative braking, electromagnet energy of the motor/generator will be used to apply braking torque (i.e., electromagnetic resistance for providing torque to the powertrain) to the vehicle. If it is determined that there is no longer a sufficient amount of storage means to store energy recovered from the regenerative braking or if the regenerative braking cannot meet the demands of the operator, hydraulic braking will be activated to complete all or part of the braking action demanded by the operator. Preferably, the hydraulic braking operates in a regenerative brake blending manner so that the blending is effectively and unnoticeably picked up where the electromagnetic braking left off. It is desired that the vehicle movement should have a smooth transitional change to the hydraulic braking such that the changeover goes unnoticed by the driver of the vehicle.

### SUMMARY

This disclosure relates to a brake system having a wheel brake and is operable under a non-failure normal braking mode and a manual push-through mode. The system includes a master cylinder operable by a brake pedal during a manual push-through mode to provide fluid flow at an output for actuating the wheel brake. A first source of pressurized fluid provides fluid pressure for actuating the wheel brake under a normal braking mode. A second source of pressurized fluid generates brake actuating pressure for actuating the wheel brake under the manual push-through mode.

Various aspects of this disclosure will become apparent to those skilled in the art from the following detailed description of the preferred embodiment, when read in light of the accompanying drawings.

### BRIEF DESCRIPTION OF THE DRAWINGS

FIG. 1 is a schematic illustration of a first embodiment of a brake system.

FIG. 2 is an enlarged cross-sectional schematic illustration of the three piston master cylinder of the brake system of FIG. 1.

FIG. 3 is an enlarged cross-sectional schematic illustration of the plunger assembly of the brake system of FIG. 1.

FIG. 4 is a schematic illustration of a second embodiment of a brake system including.

FIG. 5 is an enlarged cross-sectional schematic illustration of the fluid separator of the brake system illustrated in FIG. 5.

FIG. 6 is a schematic illustration of a third embodiment of a brake system.

FIG. 7 is an enlarged cross-sectional schematic illustration of the two piston master cylinder of the brake system of FIG. 6.

FIG. 8 is an enlarged cross-sectional schematic illustration of the fluid separator of the brake system of FIG. 6.

FIG. 9 is a cross-sectional view of a more detailed embodiment of a fluid separator which may be used as the fluid separator in the brake system of FIG. 6.

FIG. 10 is a schematic illustration of a fourth embodiment of a brake system.

FIG. 11 is a schematic illustration of a fifth embodiment of a brake system.

FIG. 12 is a schematic illustration of a sixth embodiment of a brake system.

FIG. 13 is an enlarged cross-sectional schematic illustration of the flow intensifier of the brake system of FIG. 12.

FIG. 14 is a schematic illustration of a seventh embodiment of a brake system.

FIG. 15 is an enlarged cross-sectional schematic illustration of the low pressure accumulator of the brake system of FIG. 14.

FIG. 16 is a schematic illustration of an eighth embodiment of a brake system.

FIG. 17 is a schematic illustration of a ninth embodiment of a brake system.

FIG. 18 is an enlarged cross-sectional schematic illustration of the flow intensifier of the brake system of FIG. 17.

FIG. 19 is a cross-sectional view of a more detailed embodiment of a flow intensifier which may be used as the flow intensifier in the brake system of FIG. 17.

FIG. 20 is a cross-sectional view of a more detailed embodiment of a low pressure accumulator which may be used as the low pressure accumulator in the brake system of FIG. 17.

FIG. 21 is a schematic illustration of a tenth embodiment of a brake system.

FIG. 22 is a schematic illustration of an eleventh embodiment of a brake system.

FIG. 23 is a schematic illustration of a twelfth embodiment of a brake system.

FIG. 24 is an enlarged cross-sectional schematic illustration of an alternate embodiment of a fluid separator.

### DETAILED DESCRIPTION

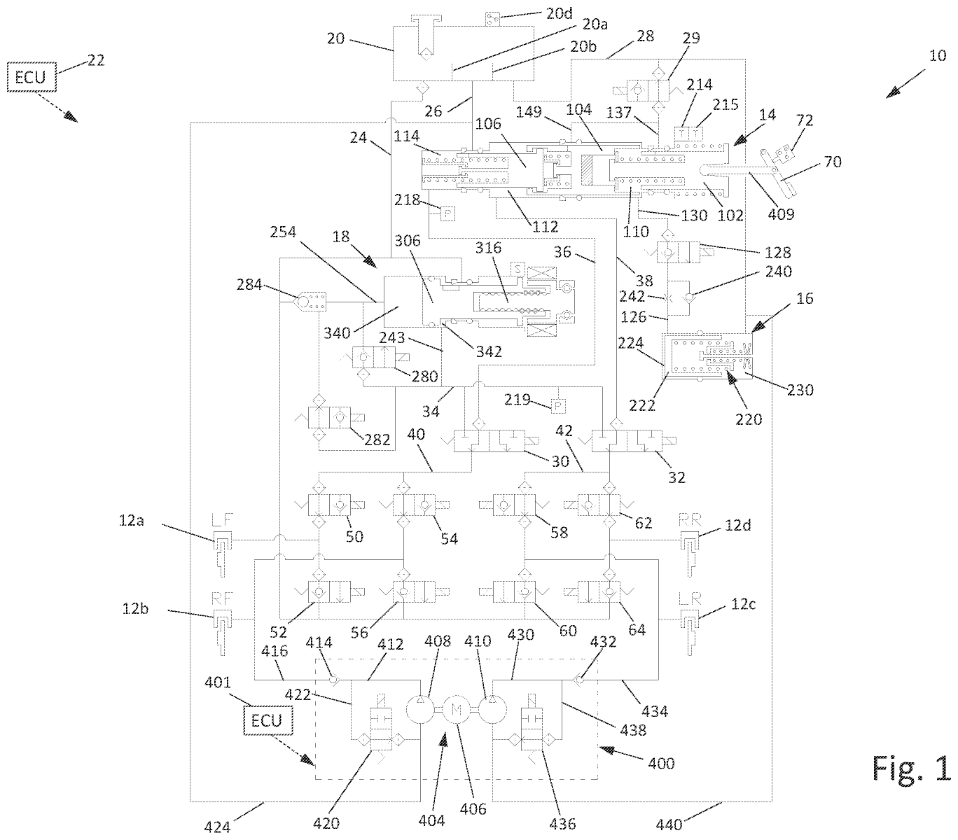

Referring now to the drawings, there is schematically illustrated in FIG. 1 a first embodiment of a vehicle brake system, indicated generally at 10. The brake system 10 is a hydraulic braking system in which fluid pressure from a source is operated to apply braking forces for the brake system 10. The brake system 10 may suitably be used on a ground vehicle such as an automotive vehicle having four wheels. Furthermore, the brake system 10 can be provided with other braking functions such as anti-lock braking (ABS) and other slip control features to effectively brake the vehicle, as will be discussed below. In the illustrated embodiment of the brake system 10, there are four wheel brakes 12a, 12b, 12c, and 12d. The wheel brakes 12a, 12b, 12c, and 12d can have any suitable wheel brake structure operated by the application of pressurized brake fluid. The wheel brakes 12a, 12b, 12c, and 12d may include, for example, a brake caliper mounted on the vehicle to engage a frictional element (such as a brake disc) that rotates with a vehicle wheel to effect braking of the associated vehicle wheel.

The wheel brakes 12a, 12b, 12c, and 12d can be associated with any combination of front and rear wheels of the vehicle in which the brake system 10 is installed. A vertically split brake system is illustrated such that the wheel brake 12a is preferably associated with the left front wheel of the vehicle in which the brake system 10 is installed. A wheel brake 12b is preferably associated with the right front wheel. A wheel brake 12c is preferably associated with the left rear wheel. A wheel brake 12d is preferably associated with the right rear front wheel. Alternatively, the brake system 10 could be configured in a diagonally split system such that the wheel brake 12a is associated with the left rear wheel, the wheel brake 12b is associated with the right front wheel, the wheel brake 12c is associated with the left front wheel, and the wheel brake 12d is associated with the right rear wheel.

The brake system 10 includes a master cylinder, indicated generally at 14, a pedal simulator, indicated generally at 16, a plunger assembly, indicated generally at 18, and a reservoir 20. As will be discussed in detail below, the plunger assembly 18 of the brake system 10 functions as a source of pressure to provide a desired pressure level to the wheel brakes 12a, 12b, 12c, and 12d during a typical or normal brake apply. Fluid from the wheel brakes 12a, 12b, 12c, and 12d may be returned to the plunger assembly 18 and/or diverted to the reservoir 20. The master cylinder 14, the pedal simulator 16, and the plunger assembly 18 will be described in greater detail below.

The reservoir 20 stores and holds hydraulic fluid for the brake system 10. The fluid within the reservoir 20 is preferably held at or about atmospheric pressure but may store the fluid at other pressures if so desired. Ideally, the pressure within the reservoir is relatively low and is ideally less than 1 bar above atmospheric pressure. The fluid reservoir 20 is shown schematically having three sections with three conduit lines 24, 26, and 28 connected thereto. The sections can be separated by a couple of interior walls 20a and 20b within the reservoir 20 and are provided to prevent complete drainage of the reservoir 20 in case one of the sections is depleted due to a leakage in one of the three conduits 24, 26, and 28 connected to the reservoir 20. Alternatively, the reservoir 20 may include multiple separate housings.

The brake system 10 may include a fluid level sensor 20d for detecting the fluid level of the reservoir 20. The brake system 10 also includes a solenoid actuated normally open simulator test valve 29 in fluid communication with the conduit 28 and the master cylinder 14, the reason for which will be explained below.

The brake system 10 includes a main electronic control unit (ECU) 22. The main ECU 22 may include microprocessors. The main ECU 22 receives various signals, processes signals, and controls the operation of various electrical components of the brake system 10 in response to the received signals. The main ECU 22 can be connected to various sensors such as pressure sensors, travel sensors, switches, wheel speed sensors, and steering angle sensors. The main ECU 22 may also be connected to an external module (not shown) for receiving information related to yaw rate, lateral acceleration, longitudinal acceleration of the vehicle such as for controlling the brake system 10 during vehicle stability operation. Additionally, the main ECU 22 may be connected to the instrument cluster for collecting and supplying information related to warning indicators such as an ABS warning light, a brake fluid level warning light, and a traction control/vehicle stability control indicator light.

The brake system 10 further includes first and second isolation valves 30 and 32. The isolation valves 30 and 32 may be solenoid actuated three way valves. The isolation valves 30 and 32 are generally operable to two positions, as schematically shown in FIG. 1. The first and second isolation valves 30 and 32 each have a port in selective fluid communication with an output conduit 34 generally in communication with an output of the plunger assembly 18, as will be discussed below. The first and second isolation valves 30 and 32 also includes ports that are selectively in fluid communication with conduits 36 and 38, respectively, from the master cylinder 14 when the first and second isolation valves 30 and 32 are non-energized, as shown in FIG. 1. The first and second isolation valves 30 and 32 further include ports that are in fluid communication with conduits 40 and 42, respectively, which provide fluid to and from the wheel brakes 12a, 12b, 12c, and 12d.

In a preferred embodiment, the first and/or second isolation valves 30 and 32 may be mechanically designed such that flow is permitted to flow in the reverse direction (from conduit 34 to the conduits 36 and 38, respectively) when in their de-energized positions and can bypass the normally closed seat of the valves 30 and 32. Thus, although the 3-way valves 30 and 32 are not shown schematically to indicate this fluid flow position, it is noted that that the valve design may permit such fluid flow. This may be helpful in performing self-diagnostic tests of the brake system 10.

The system 10 further includes various solenoid actuated valves (slip control valve arrangement) for permitting controlled braking operations, such as ABS, traction control, vehicle stability control, and regenerative braking blending. A first set of valves includes a first apply valve 50 and a first dump valve 52 in fluid communication with the conduit 40 for cooperatively supplying fluid received from the first isolation valve 30 to the wheel brake 12a, and for cooperatively relieving pressurized fluid from the wheel brake 12a to the reservoir conduit 24 in fluid communication with the reservoir 20. A second set of valves includes a second apply valve 54 and a second dump valve 56 in fluid communication with the conduit 40 for cooperatively supplying fluid received from the first isolation valve 30 to the wheel brake 12b, and for cooperatively relieving pressurized fluid from the wheel brake 12b to the reservoir conduit 24. A third set of valves includes a third apply valve 58 and a third dump valve 60 in fluid communication with the conduit 42 for cooperatively supplying fluid received from the second isolation valve 32 to the wheel brake 12c, and for cooperatively relieving pressurized fluid from the wheel brake 12c to the reservoir conduit 24. A fourth set of valves includes a fourth apply valve 62 and a fourth dump valve 64 in fluid communication with the conduit 42 for cooperatively supplying fluid received from the second isolation valve 32 to the wheel brake 12d, and for cooperatively relieving pressurized fluid from the wheel brake 12d to the reservoir conduit 24. Note that in a normal braking event, fluid flows through the non-energized open apply valves 50, 54, 58, and 62. Additionally, the dump valves 52, 56, 60, and 64 are preferably in their non-energized closed positions to prevent the flow of fluid to the reservoir 20.

The master cylinder 14 is connected to a brake pedal 70 and is actuated by the driver of the vehicle as the driver presses on the brake pedal 70. A brake sensor or switch 72 may be connected to the main ECU 22 to provide a signal indicating a depression of the brake pedal 70. As will be discussed below, the master cylinder 14 may be used as a back-up source of pressurized fluid to essentially replace the normally supplied source of pressurized fluid from the plunger assembly 18 under certain failed conditions of the brake system 10. The master cylinder 14 can supply pressurized fluid in the conduits 36 and 38 (that are normally closed off at the first and second isolation valves 30 and 32 during a normal brake apply) to the wheel brake 12a, 12b, 12c, and 12d as required.

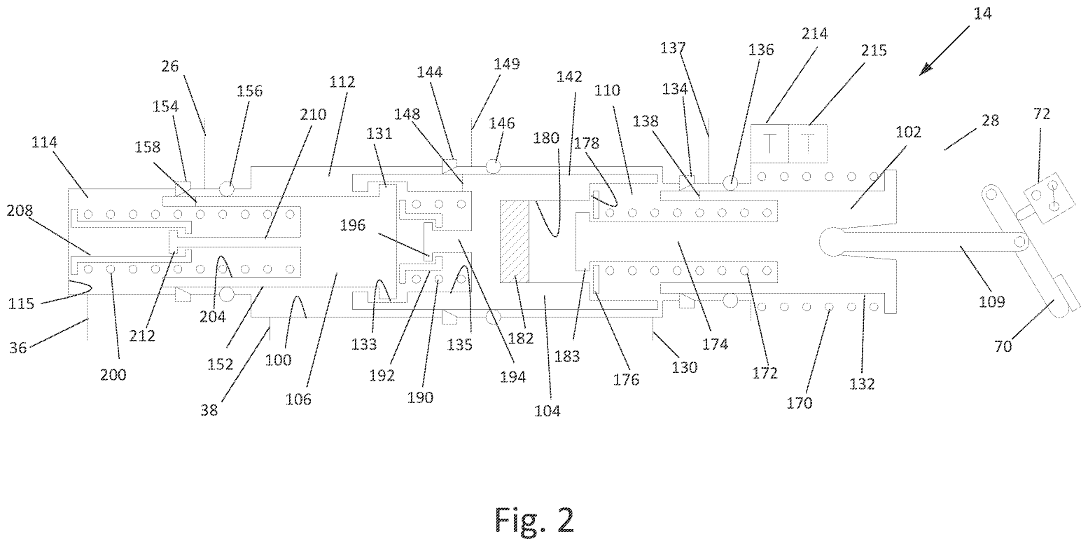

Referring now to the enlarged schematic representation of the master cylinder 14 as shown in FIG. 2, the master cylinder 14 includes a housing with a multi-stepped bore 100 formed therein. Note that the housing is not specifically schematically shown in FIGS. 1 and 2 but instead the walls of the bore 100 are illustrated. The housing may be formed as a single unit or include two or more separately formed portions coupled together. An input piston 102, a primary piston 104, and a secondary piston 106 are slidably disposed within the bore 100. The input piston 102 is connected with the brake pedal 70 via a linkage arm 109. As will be described in further detail below, leftward movement of the input piston 102, the primary piston 104, and the secondary piston 106 may cause, under certain conditions, a pressure increase within an input chamber 110, a primary chamber 112, and a secondary chamber 114, respectively. Various seals of the master cylinder 14 as well as the structure of the housing and the pistons 102, 104, and 106 define the chambers 110, 112, and 114. For example, the input chamber 110 is generally defined between the input piston 102 and the primary piston 104. The primary chamber 112 is generally defined between the primary piston 104 and the secondary piston 106. The secondary chamber 114 is generally defined between the secondary piston 106 and an end wall 115 of the housing formed by the bore 100.

The input chamber 110 is in fluid communication with the pedal simulator 16 via a conduit 130. As is shown in FIG. 1, the conduit 130 is in fluid communication with a conduit 126 through a solenoid actuated simulator valve 128. Referring back to FIG. 2, the input piston 102 is slidably disposed in the bore 100 of the housing of the master cylinder 14. An outer wall 132 of the input piston 102 is engaged with a lip seal 134 and a seal 136 mounted in grooves formed in the housing. One or more lateral passageways 138 (also referred herein as compensation ports) are formed in the input piston 102. The passageway 138 is located between the lip seal 134 and the seal 136 when the input piston 102 is in its rest position wherein the brake pedal 70 has not been depressed, as is shown in FIGS. 1 and 2. In the rest position, the passageway 138 permits fluid communication between the input chamber 110 and the reservoir 20 via the open simulator test valve 29 and a conduit 137 and the conduit 28. Sufficient leftward movement of the input piston 102 will cause the passageway 138 to move past the lip seal 134, thereby preventing the flow of fluid from the input chamber 110 into the conduit 137. Note that the lip seal 134 is preferably configured to permit the flow of fluid in the opposite direction such that fluid may flow past the lip seal 134 from the conduit 137 into the input chamber 110.

As shown in FIG. 1, the primary chamber 112 is in fluid communication with the second isolation valve 32 via the conduit 38. Referring back to FIG. 2, the primary piston 104 is slidably disposed in the bore 100 of the housing of the master cylinder 14. An outer wall 142 of the primary piston 104 is engaged with a lip seal 144 and a seal 146 mounted in grooves formed in the housing. One or more lateral passageways 148 (compensation ports) are formed in the primary piston 104. As shown in FIGS. 1 and 2, the passageway 148 is located between the lip seal 144 and the seal 146 when the primary piston 104 is in its rest position. Sufficient leftward movement of the primary piston 104 will cause the passageway 148 to move past the lip seal 144, thereby preventing the flow of fluid from the primary chamber 112 into a conduit 149 in fluid communication with the reservoir 20 via the conduit 137 through the simulator test valve 29.

The secondary chamber 114 is in fluid communication with the first isolation valve 30 via the conduit 36. The secondary piston 106 is slidably disposed in the bore 100 of the housing of the master cylinder 14. An outer wall 152 of the secondary piston 106 is engaged with a lip seal 154 and a seal 156 mounted in grooves formed in the housing. One or more lateral passageways 158 (compensation ports) are formed in the secondary piston 106. As shown in FIGS. 1 and 2, the passageway 158 is located between the lip seal 154 and the seal 156 when the secondary piston 106 is in its rest position. Sufficient leftward movement of the secondary piston 106 will cause the passageway 158 to move past the lip seal 154, thereby preventing the flow of fluid from the secondary chamber 114 into the conduit 26.

If desired, the primary and secondary pistons 104 and 106 may be mechanically connected with limited movement therebetween. The mechanical connection of the primary and secondary pistons 104 and 106 prevents a large gap or distance between the primary and secondary pistons 104 and 106 and prevents having to advance the primary and secondary pistons 104 and 106 over a relatively large distance without any increase in pressure in the non-failed circuit. For example, as will be explained in detail below, the brake system 10 may be operated in a manual push through mode, in which the brake pedal 70 is depressed and the isolation valves 30 and 32 are in their deenergized state as shown in FIG. 1. Fluid pressure may be lost in the output circuit relative to the secondary piston 106, such as for example a leak in the conduit 36. In this situation, the secondary piston 106 will be forced or biased in the leftward direction due to the pressure within the primary chamber 112. If the primary and secondary pistons 104 and 106 were not connected together, the secondary piston 106 would freely travel to its further most left-hand position and the driver would have to depress the pedal 70 a distance to compensate for this loss in travel. However, because the primary and secondary pistons 104 and 106 are connected together, the secondary piston 106 is prevented from this movement and relatively little loss of travel occurs in this type of failure. Any suitable mechanical connection between the primary and secondary pistons 104 and 106 may be used. For example, as schematically shown in FIG. 2, the right-hand end of the secondary piston 106 includes an outwardly extending flange 131 that extends into a groove 133 formed in an inner wall 135 of the primary piston 104. The groove 133 has a width which is greater than the width of the flange 131, thereby providing a relatively small amount of travel between the first and secondary pistons 104 and 106 relative to one another.

The master cylinder 14 further includes a return spring 170 biasing the input piston 102 in the rightward direction as viewing FIG. 2. An input spring 172 is disposed about an axial stem 174 formed in the input piston 102 and engages with a washer 176 which is in direct contact with a shoulder 178 formed in the right-hand end of the primary piston 104. The axial stem 174 extends into a bore 180 formed in the right-hand end of the primary piston 104. An elastomeric pad 182 is disposed in the bore 180 and will engage with an enlarged head 183 formed at the end of the axial stem 174 when the input piston 102 is moved a sufficient distance towards the primary piston 104. Compression of the elastomeric pad 182 by the head 183 of the stem 174 provides for a desired spring rate characteristic.

The master cylinder 14 further includes a primary spring 190 generally disposed between the secondary piston 106 and the primary piston 104. The primary spring 190 is disposed within the inner wall 135 and engages with a retainer 192 forming a caged spring assembly configuration with an axial stem 194 extending from bottom of the inner wall 135 of the primary piston 104. The retainer 192 is restrained by an enlarged head 196 formed on the end of the axial stem 194.

The master cylinder 14 further includes a secondary spring 200 generally disposed between the secondary piston 106 and the bottom wall 115 of the bore 100. The secondary spring 200 is disposed within a bore 204 formed in the left-hand end of the secondary piston 106 and engages with a retainer 208 forming a caged spring assembly configuration with an axial stem 210 extending from the bottom of the bore 204 of the secondary piston 106. The retainer 208 is restrained by an enlarged head 212 formed on the end of the axial stem 210.

In a preferred embodiment of the brake system 10, the master cylinder 14 includes a pair of travel sensors 214 and 215 for producing signals that are indicative of the length of travel of the input piston 102 and providing the signals to the main ECU 22. The travel sensors 214 and 215 may be similar in structure and may provide for redundancy. As will be explained below, the travel sensors 214 and 215 may also be used with an auxiliary brake module 400.

As shown in FIG. 1, a pressure sensor 218 detects the pressure within the secondary pressure chamber 114 via the conduit 36 and sends a signal indicative of the pressure to the main ECU 22. A pressure sensor 219 detects the pressure within the output conduit 34 from the plunger assembly 18 and sends a signal indicative of the pressure to the main ECU 22.

As discussed above, the input chamber 110 of the master cylinder 14 is selectively in fluid communication with the reservoir 20 via the passageway 138 formed in the input piston 102 and via the conduits 137 and 28. The brake system 10 may include the optional simulator test valve 29 located within the conduit 137. The simulator test valve 29 may be electronically controlled between an open position, as shown in FIG. 1, and a powered closed position. The simulator test valve 29 is not necessarily needed during a normal boosted brake apply or for a manual push through mode. The simulator test valve 29 can be energized to a closed position during various testing modes to determine the correct operation of other components of the brake system 10. For example, the simulator test valve 29 may be energized to a closed position to prevent venting to the reservoir 20 via the conduit 28 such that a pressure build up in the master cylinder 14 can be used to monitor fluid flow to determine whether leaks may be occurring through seals of various components of the brake system 10.

As stated above, the brake system 10 includes a pedal simulator 16 and an associated solenoid actuated simulator valve 128. The pedal simulator 16, schematically shown in FIG. 1, includes a plurality of spring assemblies, indicated generally at 220. The spring assemblies 220 bias a piston 222 towards a pressure chamber 224 in fluid communication with the conduit 126 which is in fluid communication with the simulator valve 128. The spring assemblies 220 are housed in a non-pressurized chamber 230 which is in fluid communication with the conduit 28 connected to the reservoir 20. Alternatively, the pedal simulator 16 could be designed as a “dry simulator” versus a “wet simulator” such that the spring assemblies 220 are housed in a non-fluid filled chamber, thereby eliminating the need for the fluid communication with the conduit 28. The spring assemblies 220 can have any suitable configuration to provide a desired force feedback characteristic to the driver during a normal braking of the brake system 10. The spring assemblies 220 can provide a linear or non-linear progressive force feedback curve.

With regards to operation of the pedal simulator 16, initial movement of the brake pedal 70 from its rest position causes movement of the input piston 102 in the leftward direction, as viewing FIGS. 1 and 2. Sufficient leftward movement of the input piston 102 will cause the passageway 138 to move past the lip seal 134, thereby preventing fluid communication with the reservoir 20 via the conduit 28. Further leftward movement of the input piston 102 pressurize the input chamber 110 causing fluid to flow into the pedal simulator 16 via the conduit 130 and 126. As fluid is diverted into the pedal simulator 16, the simulation pressure chamber 224 within the pedal simulator 16 will expand causing movement of the piston 222 within the pedal simulator 16. Movement of the piston 222 compresses the spring assembly 220. The compression of the spring 220 provides a feedback force to the driver of the vehicle which may simulate the forces a driver feels at the brake pedal 70 in a conventional vacuum assist hydraulic brake system, for example. The spring assembly 220 of the pedal simulator 16 can include any number and types of spring members as desired. For example, the spring assembly 220 may include a combination of low rate and high rate spring elements to provide a non-linear force feedback. The solenoid actuated simulator valve 128 is positioned within the conduit 130 to selectively prevent the flow of fluid from the input chamber 110 to the simulation chamber 224, such as during a failed condition in which the master cylinder 14 is utilized to provide a source of pressurized fluid to the wheel brakes.

The brake system 10 may include an optional check valve 240 in parallel with a restricted orifice 242 positioned within the conduit 126. This configuration may help suppress rapid pressure increases during a spike apply in which the driver of the vehicle rapidly and forcefully depresses the brake pedal 70.

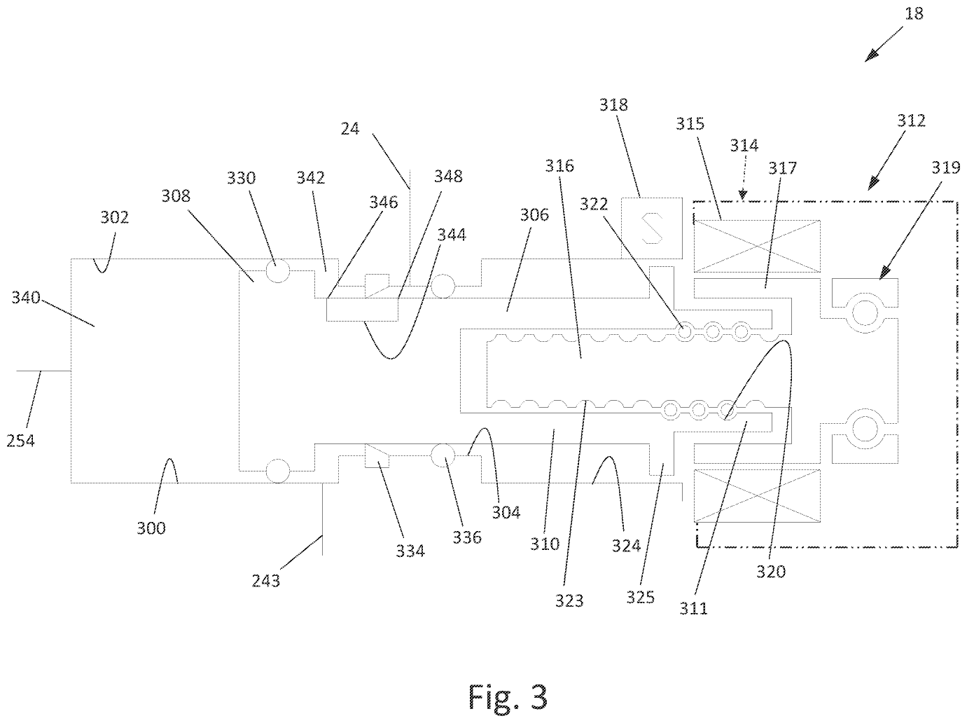

As shown schematically in FIG. 3, the plunger assembly 18 includes a housing having a multi-stepped bore 300 formed therein. Note that the housing is not specifically schematically shown in FIGS. 1 and 3 but instead the walls of the bore 300 are illustrated. The bore 300 includes a first portion 302 and a second portion 304. A piston 306 is slidably disposed within the bore 300. The piston 306 includes an enlarged end portion 308 connected to a smaller diameter central portion 310. The piston 306 has a second end 311 connected to a ball screw mechanism, indicated generally at 312. The ball screw mechanism 312 is provided to impart translational or linear motion of the piston 306 along an axis defined by the bore 300 in both a forward direction (leftward as viewing FIGS. 1 and 3), and a rearward direction (rightward as viewing FIGS. 1 and 3) within the bore 300 of the housing.

In the embodiment shown, the ball screw mechanism 312 includes a motor, indicated schematically and generally at 314, which is electrically connected to the main ECU 22 for actuation thereof. The motor 314 rotatably drives a screw shaft 316. The motor 314 generally includes a stator 315 and a rotor 317. In the schematic embodiment shown in FIG. 3, the rotor 317 and the screw shaft 316 are integrally formed together. However, it should be understood that they can be formed from separate parts fixedly connected together. The rotor 317 and the screw shaft 316 are rotatably mounted to the housing of the plunger assembly 18 by a bearing assembly, indicated generally at 319. The second end 311 of the piston 306 includes a threaded bore 320 and functions as a driven nut of the ball screw mechanism 312. The ball screw mechanism 312 includes a plurality of balls 322 that are retained within helical raceways 323 formed in the screw shaft 316 and the threaded bore 320 of the piston 306 to reduce friction. Although a ball screw mechanism 312 is shown and described with respect to the plunger assembly 18, it should be understood that other suitable mechanical linear actuators may be used for imparting movement of the piston 306. It should also be understood that although the piston 306 functions as the nut of the ball screw mechanism 312, the piston 306 could be configured to function as a screw shaft of the ball screw mechanism 312.

The piston 306 may include structures engaged with cooperating structures formed in the housing of the plunger assembly 18 to prevent rotation of the piston 306 as the screw shaft 316 rotates relative to the piston 306. For example, the piston 306 may include outwardly extending splines or tabs or splines 325 disposed within longitudinal grooves 324 formed in the housing. The splines 325 slide along within the grooves 324 as the piston 306 travels in the bore 300.

As will be discussed below, the plunger assembly 18 is preferably configured to provide pressure to the conduit 34 when the piston 306 is moved in both the forward and rearward directions. The plunger assembly 18 includes a seal 330 mounted on the enlarged end portion 308 of the piston 306. The seal 330 slidably engages with the inner cylindrical surface of the first portion 302 of the bore 300 as the piston 306 moves within the bore 300. A seal 334 and a seal 336 are mounted in grooves formed in the second portion 304 of the bore 300. The seals 334 and 336 slidably engage with the outer cylindrical surface of the central portion 310 of the piston 306. A first pressure chamber 340 is generally defined by the first portion 302 of the bore 300, the enlarged end portion 308 of the piston 306, and the seal 330. The first pressure chamber 340 is in fluid communication with a conduit 254 which is selectively in fluid communication with the output conduit 34, as will be explained below. An annular shaped second pressure chamber 342, located generally behind the enlarged end portion 308 of the piston 306, is generally defined by the first and second portions 302 and 304 of the bore 300, the seals 330 and 334, and the central portion 310 of the piston 306. The seals 330, 334, and 336 can have any suitable seal structure. The second pressure chamber 342 is in fluid communication with a conduit 243 which is in fluid communication with the output conduit 34.

Although the plunger assembly 18 may be configured to any suitable size and arrangement, in one embodiment, the effective hydraulic area of the first pressure chamber 340 is greater than the effective hydraulic area of the annular shaped second pressure chamber 342. The first pressure chamber 340 generally has an effective hydraulic area corresponding to the diameter of the central portion 310 of the piston 306 (the inner diameter of the seal 334) since fluid is diverted through the conduits 254, 34, and 243 as the piston 306 is advanced in the forward direction. The second pressure chamber 342 generally has an effective hydraulic area corresponding to the diameter of the first portion 302 of the bore 300 minus the diameter of the central portion 310 of the piston 306. If desired, the plunger assembly 18 could be configured to provide that on the back stroke in which the piston 306 is moving rearwardly, less torque (or power) is required by the motor 314 to maintain the same pressure as in its forward stroke. Besides using less power, the motor 314 may also generate less heat during the rearward stroke of piston 306. Under circumstances in which the driver presses on the pedal 70 for long durations, the plunger assembly 18 could be operated to apply a rearward stroke of the piston 306 to prevent overheating of the motor 314. Of course, it may also be desirable to configure the plunger assembly 18 such that the behavior of the rearward stroke is the same or similar to the forward stroke of the plunger assembly 18.

The plunger assembly 18 preferably includes a sensor, schematically shown as 318, for indirectly detecting the position of the piston 306 within the bore 300. The sensor 318 is in communication with the main ECU 22. In one embodiment, the sensor 318 detects the rotational position of the rotor 317 which may have metallic or magnetic elements embedded therein. Since the rotor 317 is schematically shown as being integrally formed with the shaft 316, the rotational position of the shaft 316 corresponds to the linear position of the piston 306. Thus, the position of the piston 306 can be determined by sensing the rotational position of the rotor 317 via the sensor 318. Note that due to ease of manufacturing, the rotor 317 may not be integrally formed with the shaft 316 but rather may be a separate part connected to the shaft 316.

As best shown in FIG. 3, the piston 306 of the plunger assembly 18 includes a passageway 344 formed therein. The passageway 344 defines a first port 346 extending through the outer cylindrical wall of the piston 306 and is in fluid communication with the secondary chamber 342. The passageway 344 also defines a second port 348 extending through the outer cylindrical wall of the piston 306 and is in fluid communication with a portion of the bore 300 located between the seals 334 and 336. The second port 348 is in fluid communication with the conduit 24 which is in fluid communication with the reservoir 20. When in the rest position, as shown in FIG. 3, the pressure chambers 340 and 342 are in fluid communication with the reservoir 20 via the conduit 24. This helps in ensuring a proper release of pressure at the output of the plunger assembly 18 and within the pressure chambers 340 and 342 themselves. After an initial forward movement of the piston 306 from its rest position, the port 348 will move past the lip seal 334, thereby closing off fluid communication of the pressure chambers 340 and 342 from the reservoir 20, thereby permitting the pressure chambers 340 and 342 to build up pressure as the piston 306 moves further.

Referring back to FIG. 1, the brake system 10 further includes a first plunger valve 280, and a second plunger valve 282. The first plunger valve 280 is preferably a solenoid actuated normally closed valve. Thus, in the non-energized state, the first plunger valve 280 is in a closed position, via a check valve arrangement, as shown in FIG. 1. The second plunger valve 282 is preferably a solenoid actuated normally open valve. Thus, in the non-energized state, the second plunger valve 282 is in an open position, as shown in FIG. 1. A check valve may be arranged within the second plunger valve 282 so that when the second plunger valve 282 is in its closed position, fluid may still flow through the second plunger valve 282 in the direction from the conduit 254 (from the first pressure chamber 340 of the plunger assembly 18) to the output conduit 34 leading to the isolation valves 30 and 32. Note that during a rearward stroke of the piston 306 of the plunger assembly 18, pressure may be generated in the second pressure chamber 342 for output into the output conduit 34. The brake system 10 further includes a check valve 284 permitting fluid to flow in the direction from the conduit 24 (from the reservoir 20) to the conduit 254 and into the first pressure chamber 340 of the plunger assembly 18 such as during a pressure generating rearward stroke of the piston 306.

Generally, the first and second plunger valves 280 and 282 are controlled to permit fluid flow at the outputs of the plunger assembly 18 and to permit venting to the reservoir 20 through the plunger assembly 18 when so desired. For example, the first plunger valve 280 is preferably energized to its open position during a normal braking event. Additionally, it is preferred that both the first and second plunger valves 280 and 282 remain open (which may reduce noise during operation). Preferably, the first plunger valve 280 is almost always energized during an ignition cycle when the engine is running. Of course, the first and second plunger valves 280 and 282 may be purposely operated to their closed positions such as during a pressure generating rearward stroke of the plunger assembly 18 or during a hill hold brake operation. The first and second plunger valves 280 and 282 are preferably in their open positions when the piston 306 of the plunger assembly 18 is operated in its forward stroke to maximize flow. When the driver releases the brake pedal 70, the first and second plunger valves 280 and 282 preferably remain in their open positions. However, under certain circumstances, such as during slip control and the driver is pushing hard on the brake pedal 70 during controlled low pressures and then the driver releases half way on the brake pedal 70, it may be desirable to operate the first and second plunger valves 280 and 282 to their closed positions. Note that fluid can flow through the check valve within the closed second plunger valve 282, as well as through the check valve 284 from the reservoir 20 depending on the travel direction of the piston 306 of the plunger assembly 18 and the state of the first and second plunger valves 280 and 282.

It may be desirable to configure the first plunger valve 280 with a relatively large orifice therethrough when in its open position. A relatively large orifice of the first plunger valve 280 helps to provide an easy flow path therethrough. The second plunger valve 282 may be provided with a much smaller orifice in its open position as compared to the first plunger valve 280. One reason for this is to help prevent the piston 306 of the plunger assembly 18 from rapidly being back driven upon a failed event due to the rushing of fluid through the first output conduit 254 into the first pressure chamber 340 of the plunger assembly 18, thereby preventing damage to the plunger assembly 18. As fluid is restricted in its flow through the relatively small orifice, dissipation will occur as some of the energy is transferred into heat. Thus, the orifice should be of a sufficiently small size so as to help prevent a sudden catastrophic back drive of the piston 306 of the plunger assembly 18 upon failure of the brake system 10, such as for example, when power is interrupted or lost to the motor 314 and the pressure within the output conduit 34 is relatively high.

The plunger assembly 18 may include an optional spring member (not shown), to assist in cushioning such a rapid rearward back drive of the piston 306. The spring washer may be located just behind the enlarged portion 308 of the piston 306. The spring washer may also assist in cushioning the piston 306 moving at any such speed as it approaches a rest position near its most retracted position within the bore 300. It is noted that although the isolation valves 30 and 32 could shuttle to their positions shown in FIG. 1 during a power failure, the presence of the spring washer enables the isolation valves 30 and 32 to be made cheaply with a smaller solenoid wherein they might hydraulically lock and not shuttle, thereby allowing this rapid rearward back drive of the piston 306. The spring washer can also function as a parking element such that the piston 306 can lightly hit the spring washer on a return stroke to determine its homing, start or at rest position. When it is detected that the piston 306 has stopped moving by hitting the spring washer, the homing position can be determined.

The first and second plunger valves 280 and 282 provide for an open parallel path between the pressure chambers 340 and 342 of the plunger assembly 18 during a normal braking operation (with the first plunger valve 280 energized). Although a single open path may be sufficient, the advantage of having both the first and second plunger valves 280 and 282 is that the first plunger valve 280 may provide for an easy flow path through the relatively large orifice thereof, while the second plunger valve 282 may provide for a restricted orifice path during certain failed conditions (when the first plunger valve 280 is de-energized to its closed position). It is noted that a single normally open valve with a relatively large orifice could be sufficient instead of the two plunger valves 280 and 282, however, the single valve may need a relatively large solenoid and during power losses the single valve could close causing possible locking of the isolation valves 30 and 32.

The brake system 10 further includes an auxiliary brake module, indicated generally at 400, as shown in FIG. 1. The auxiliary brake module 400 may function as a second source of pressurized fluid, such as under certain failed conditions of the brake system 10 as will be explained below. As a secondary source of pressurized fluid, the auxiliary brake module 400 provides an added volume of fluid to the brake system 10 during a manual push through operation, as will be explained below. The auxiliary brake module 400 may be housed in a different block or unit remotely located from the remainder of the brake system 10, or may be housed integrally therewith.

The auxiliary brake module 400 may further include a secondary ECU 401 (separate from the main ECU 22) for controlling the various valves and components of the auxiliary brake module 400. The secondary ECU 401 may also be in communication with the ECU 22. In a preferred embodiment, the secondary ECU 401 is also in communication with one or more of the travel sensors 214 and 215, the reason for which will be explained below.

The main ECU 22 and the secondary ECU 401 may both be connected to a vehicle CAN bus (Controller Area Network bus) for receiving various signals and controls. Both the main ECU 22 and the secondary ECU 401 may send out signals over the CAN bus indicating that they are operating properly. These signals may be received by the other of the ECU 22 and 401. For example, once the secondary ECU 401 does not receive the signal from the main ECU 22 over the CAN bus of proper operation of the main ECU 22, the secondary ECU 401 may begin operating the auxiliary brake module 400, as will be described below.

The secondary ECU 401 may even function as a fail-safe back up in case the main ECU 22 fails. It should be understood that the brake system 10 could be configured such that the main ECU 22 also controls the auxiliary brake module 400. Alternatively, the secondary ECU 401 may be eliminated such that the main ECU 22 controls the entire brake system 10 including the auxiliary brake module 400.

The auxiliary brake module 400 further includes a pump assembly, indicated generally at 404. In the embodiment shown, the pump assembly 404 includes a single electric motor 406 controlled by the secondary ECU 401. The pump assembly 404 includes first and second pumps 408 and 410 operated by the motor 406. Of course, the pump assembly 404 can have any suitable configuration other than what is schematically shown in FIG. 1.

The outlet of the pump 408 is directed into a conduit 412 which is in fluid communication with a check valve 414. A conduit 416 extends between the check valve 418 and the wheel brake 12b. A solenoid actuated pump valve 420 is controllable by the secondary ECU 401 and is positioned in a conduit 422 extending between the outlet and inlet of the pump 408. The inlet of the pump 408 is in fluid communication with the reservoir 20 via a conduit 424 which in fluid communication with the conduit 26. If the auxiliary brake module 400 is located remotely from the remainder of the brake system 10, the conduit 424 is preferably a hose or pipe having a sufficiently large diameter to permit the easy flow of fluid therethrough. This relatively large diameter helps to assure that the pump 408 can quickly start pumping a sufficient amount of fluid when first turned on especially during extreme cold temperatures.

The outlet of the pump 410 is directed into a conduit 430 which is in fluid communication with a check valve 432. A conduit 434 extends between the check valve 432 and the wheel brake 12c. A solenoid actuated pump valve 436 is controllable by the secondary ECU 401 and is positioned in a conduit 438 extending between the outlet and inlet of the pump 410. The inlet of the pump 410 is in fluid communication with the reservoir 20 via a conduit 440 which in fluid communication with the conduit 28. As with the conduit 424, the conduit 440 is preferably a hose, pipe, or bored conduit having a sufficiently large diameter to permit the easy flow of fluid therethrough. Since the conduits 424 and 440 are connected to the reservoir 20, the pressure of the fluid supplied to the inlet of the pumps 408 and 410 is relatively low. Ideally, the fluid pressure of the reservoir 20 is at about atmospheric pressure and is preferably less than 1 bar above atmospheric pressure.

The operation of the brake system 10 will now be described. It is noted that the terms “normal braking” or “normal brake apply” generally refers to a braking event in which all of the components of the brake system 10 are functioning normally. Additionally, under a normal braking event, the brake system 10 is not experiencing any detrimental leakage that could hinder proper operation of the brake system 10. FIGS. 1 and 2 illustrate the brake system 10 and the master cylinder 14 in their rest positions. In this condition, the driver is not depressing the brake pedal 70. In a non-autonomous braking event, the brake pedal 70 is depressed by the driver of the vehicle indicating their intent in actuating the brake system 10 to decelerate the vehicle. The main ECU 22 detects this braking event by signals from the travel sensors 214 and/or 215. The pressure sensor 218 may also be used to indicate depression and/or operation of the brake pedal 70. Additionally, the brake switch 72 may be used to indicate depression of the brake pedal 70.

During a normal brake apply braking operation, the flow of pressurized fluid from the master cylinder 14 generated by depression of the brake pedal 70 is diverted into the pedal simulator 16. The simulation valve 128 is actuated or energized to divert fluid through the simulation valve 128 from the input chamber 110 of the master cylinder 14 as the input piston 102 is moved via the brake pedal 70. Note that fluid flow from the input chamber 110 to the reservoir 20 is closed off once the passageway 138 in the input piston 102 moves past the lip seal 134. As the input piston 102 generates fluid pressure within the input chamber 110, the pressurized fluid is diverted into the pressure chamber 224 of the pedal simulator 16. The build-up of pressure within the pressure chamber 224 of the pedal simulator 16 moves the piston 222 against the bias of the spring assembly 220. Compression of the spring assembly 220 provides a force feedback to the driver of vehicle as the driver feels the resistance on the driver's foot via the brake pedal 70.

During this normal braking operation, the plunger assembly 18 is operated to provide pressure to the conduit 34 for actuation of the wheel brakes 12a, 12b, 12c, and 12d. Under certain driving conditions, the main ECU 22 communicates with a powertrain control module (not shown) and other additional braking controllers of the vehicle to provide coordinated braking during advanced braking control schemes (e.g., anti-lock braking (AB), traction control (TC), vehicle stability control (VSC), and regenerative brake blending).

During the duration of a normal braking event, the simulator valve 128 remains open, preferably. Also during the normal braking operation, the isolation valves 30 and 32 are energized to secondary positions to prevent the flow of fluid from the conduits 36 and 38 through the isolation valves 30 and 32, respectively. Note that the primary and secondary chambers 112 and 114 of the master cylinder 14 are not in fluid communication with the reservoir 20 due to the passageways 148 and 158 of the primary and secondary pistons 104 and 106, respectively, being positioned past the lip seals 144 and 154, respectively. Prevention of fluid flow through the isolation valves 30 and 32 hydraulically locks the primary and secondary chambers 112 and 114 of the master cylinder 14 preventing further movement of the primary and secondary pistons 104 and 106.

Preferably, the isolation valves 30 and 32 are energized throughout the duration of an ignition cycle such as when the engine is running instead of being energized on and off to help minimize noise. It is also generally desirable to maintain the isolation valves 30 and 32 energized during the normal braking mode to ensure venting of fluid to the reservoir 20 through the plunger assembly 18 such as during a release of the brake pedal 70 by the driver. As best shown in FIG. 3, the passageway 344 formed in the piston 306 of the plunger assembly 18 permits this ventilation.

As stated above, during normal braking operations, while the pedal simulator 16 is being actuated by depression of the brake pedal 70, the plunger assembly 18 can be actuated by the main ECU 22 to provide actuation of the wheel brakes 12a, 12b, 12c, and 12d. The plunger assembly 18 is operated to provide desired pressure levels to the wheel brakes 12a, 12b, 12c, and 12d instead of pressure being generated and delivered by the master cylinder 14 by the driver depressing the brake pedal 70. The main ECU 22 actuates the motor 314 of the plunger assembly 18 to rotate the screw shaft 316 in a first rotational direction. Rotation of the screw shaft 316 in the first rotational direction causes the piston 306 to advance in the forward direction (leftward as viewing FIGS. 1 and 3). Movement of the piston 306 causes a pressure increase in the first pressure chamber 340 and fluid to flow out of the first pressure chamber 340 and into the conduit 254. Fluid can flow into the conduit 34 via the energized open first plunger valve 280 as well as the normally open second plunger valve 282. Note that fluid is permitted to flow into the second pressure chamber 342 via the conduit 243 as the piston 306 advances in the forward direction. Pressurized fluid from the conduit 34 is directed into the conduits 40 and 42 through the energized isolation valves 30 and 32. The pressurized fluid from the conduits 40 and 42 can be directed to the wheel brakes 12a, 12b, 12c, and 12d through open apply valves 50, 54, 58, and 62 while the dump valves 52, 56, 60, and 64 remain closed.

When the driver lifts off or releases the brake pedal 70, the main ECU 22 can operate the motor 314 of the plunger assembly 18 to rotate the screw shaft 316 in a second rotational direction, opposite the first rotational direction, causing the piston 306 to retract in the right-hand direction, as viewing FIGS. 1 and 3, thereby withdrawing the fluid from the wheel brakes 12a, 12b, 12c, and 12d. The speed and distance of the retraction of the piston 306 is based on the demands of the driver releasing the brake pedal 70 as sensed by the travel sensors 214 and/or 215. Under certain conditions, the pressurized fluid from the wheel brakes 12a, 12b, 12c, and 12d may assist in back-driving the ball screw mechanism 312 moving the piston 306 back towards its rest position.

In some situations, the piston 306 of the plunger assembly 18 may reach its full stroke length within the bore 300 of the housing while additional boosted pressure is still desired to be delivered to the wheel brakes 12a, 12b, 12c, and 12d. Preferably, the plunger assembly 18 is a dual acting plunger assembly such that it is configured to also provide boosted pressure to the conduit 34 when the piston 306 is stroked rearwardly (rightward) or in a reverse direction. This has the advantage over a conventional plunger assembly that requires its piston to be brought backward before it can again advance the piston to create pressure within a single pressure chamber. If the piston 306 has reached its full stroke, for example, and additional boosted pressure is still desired, the second plunger valve 282 is energized to its closed check valve position. The first plunger valve 280 is de-energized to its normally closed position. The main ECU 22 actuates the motor 314 of the plunger assembly 18 in the second rotational direction to rotate the screw shaft 316 in the second rotational direction. Rotation of the screw shaft 316 in the second rotational direction causes the piston 306 to retract or move in the rearward direction (rightward as viewing FIGS. 1 and 3). Movement of the piston 306 causes a pressure increase in the second pressure chamber 342 and fluid to flow out of the second pressure chamber 342 and into the conduit 243 and the conduit 34. Pressurized fluid from the conduit 34 is directed into the conduits 40 and 42 through the isolation valves 30 and 32. The pressurized fluid from the conduits 40 and 42 can be directed to the wheel brakes 12a, 12b, 12c, and 12d through the opened apply valves 50, 54, 58, and 62 while dump valves 52, 56, 60, and 64 remain closed.

In a similar manner as during a forward stroke of the piston 306, the main ECU 22 can also selectively actuate the apply valves 50, 54, 58, and 62 and the dump valves 52, 56, 60, and 64 to provide a desired pressure level to the wheel brakes 12a, 12b, 12c, and 12d, respectively. When the driver lifts off or releases the brake pedal 70 during a pressurized rearward stroke of the plunger assembly 18, the first and second plunger valves 280 and 282 are preferably operated to their open positions, although having only one of the valves 280 and 282 open would generally still be sufficient. Note that when transitioning out of a slip control event, the ideal situation would be to have the position of the piston 306 and the displaced volume within the plunger assembly 18 correlate exactly with the given pressures and fluid volumes within the wheel brakes 12a, 12b, 12c, and 12d. However, when the correlation is not exact, such as for example, when there is excess fluid within the plunger assembly 18, fluid can escape via the passageway 344 to the reservoir 20. In situations where there is a deficiency of fluid, fluid can be drawn from the reservoir 20 via the check valve 284 into the chamber 340 of the plunger assembly 18.

During a braking event, the main ECU 22 can selectively actuate the apply valves 50, 54, 58, and 62 and the dump valves 52, 56, 60, and 64 to provide a desired pressure level to the wheel brakes, respectively. The main ECU 22 can also control the brake system 10 during ABS, DRP, TC, VSC, regenerative braking, and autonomous braking events by general operation of the plunger assembly 18 in conjunction with the apply valves and the dump valves. Even if the driver of the vehicle is not depressing the brake pedal 70, the main ECU 22 can operate the plunger assembly 18 to provide a source of pressurized fluid directed to the wheel brakes, such as during an autonomous vehicle braking event.

In the event of a loss of electrical power to portions of the brake system 10, the brake system 10 provides for manual push through or manual apply such that the master cylinder 14 can supply relatively high pressure fluid to the conduits 36 and 38. During an electrical failure, the motor 314 of the plunger assembly 18 might cease to operate, thereby failing to produce pressurized hydraulic brake fluid from the plunger assembly 18. The isolation valves 30 and 32 will shuttle (or remain) in their positions to permit fluid flow from the conduits 36 and 38 to the wheel brakes 12a, 12b, 12c, and 12d. The simulator valve 128 is shuttled to its normally closed position to prevent fluid from flowing out of the input chamber 110 of the master cylinder 14 to the pedal simulator 16. During the manual push-through apply, the input piston 102, the primary piston 104, and the secondary piston 106 will advance leftwardly such that the passageways 138, 148, 158 will move past the seals 134, 144, and 154, respectively, to prevent fluid flow from their respective fluid chambers 110, 112, and 114 to the reservoir 20, thereby pressurizing the chambers 110, 112, and 114. Fluid flows from the primary and secondary chambers 112 and 114 into the conduits 38 and 36, respectively, to actuate the wheel brakes 12a, 12b, 12c, and 12d.

The operation of the auxiliary brake module 400 will now be explained relative to the brake system 10 undergoing a manual push through event. The brake system 10 is ideally suited for vehicles, such as trucks, that have wheel brakes requiring a relatively high volume of fluid for full operation thereof. Thus, these vehicles may demand a brake system capable of providing a relatively large volume of fluid to the wheel brakes compared to brake systems designed for smaller passenger vehicles. This may be especially true in a failed condition when the brake system 10 is undergoing a manual push through operation. The brake system 10 can provide an increased volume of fluid for the front and rear circuits via the auxiliary brake module 400. For example, if an electrical failure occurred in the brake system 10, the auxiliary brake module 400 may be operated to provide an extra volume of fluid function to the front and rear wheel brakes. The auxiliary brake module 400 may be located remotely and/or electrically disconnected therefrom for such a reason.

The auxiliary brake module 400 may be operated when the brake system 10 undergoes a manual push through event. For example, in such a failed condition, the plunger assembly 18 may not be capable of providing the desired fluid pressure to the wheel brakes and electrical power may not be available to energize the valves of the brake system 10. If a failed condition occurred prior to the driver applying the brakes (pushing on the brake pedal 70), when the driver pushes on the brake pedal 70, fluid from the primary and secondary chambers 112 and 114 of the master cylinder 14 will be diverted through the deenergized isolation valves 30 and 32, respectively. The rear wheel brakes 12c and 12d will receive pressurized fluid in a rear fluid circuit from the primary chamber 112 of the master cylinder 14. Similarly, the front wheel brakes 12a and 12b will receive pressurized fluid in a front fluid circuit from the secondary chamber 114 of the master cylinder 14. For larger vehicles with wheel brakes having a relatively large volume of fluid, the driver would normally have to press the brake pedal 70 a relatively long distance during a manual push through event. To assist the driver in reducing the pedal travel length required, the auxiliary brake module 400 may be operated by the secondary ECU 401 (or possibly the main ECU 22) to add additional pressurized fluid (in addition to the fluid provided by the master cylinder 14) to the wheel brakes 12a, 12b, 12c, and 12d.

During operation of the auxiliary brake module 400, the secondary ECU 401 energizes the motor 406 to operate the pumps 408 and 410. Pressurized fluid from the outlet of the pump 408 is directed through the conduit 412 past the check valve 414 and into the conduit 416. This pressurized fluid is introduced into the right front wheel brake 12b in addition to the pressurized fluid from the master cylinder 14 via the conduit 36 and through the isolation valve 30 and the open apply valve 54. The fluid path from the pump 408 to the left front wheel brake 12a is greater (or more restricted) compared to the path to the right front wheel brake 12b just described. Pressurized fluid from the outlet of the pump 408 is directed through the conduit 412 past the check valve 414, into the conduit 416, through the open apply valve 54, and then through the open apply valve 50. Thus, the flow pressure path for the left front wheel brake 12a is more restricted than the path to the right front wheel brake 12b.

With regard to the rear wheel brakes, pressurized fluid from the outlet of the pump 410 is directed through the conduit 430 past the check valve 432 and into the conduit 434. This pressurized fluid is introduced into the left rear wheel brake 12c in addition to the pressurized fluid from the master cylinder 14 via the conduit 38 and through the isolation valve 32 and the open apply valve 58. The fluid path from the pump 410 to the right rear wheel brake 12d is greater (or more restricted) compared to the path to the left rear wheel brake 12c just described. Pressurized fluid from the outlet of the pump 410 is directed through the conduit 430 past the check valve 432, into the conduit 434, through the open apply valve 58, and then through the open apply valve 62. Thus, the flow pressure path for the right rear wheel brake 12d is more restricted than the path to the left rear wheel brake 12c.

As stated above, the flow pressure path to the left front wheel brake 12a and the right rear wheel brake 12d is more restricted than the other two wheel brakes. In this preferred embodiment the pressure to all wheel brakes will eventually equalize. However, under a relatively fast apply, the pressure in the right front wheel brake 12b and the left rear wheel brake 12c will be temporarily greater than the other two wheel brakes. Since the left front wheel brake 12a and the right rear wheel brake 12d are arranged in a diagonally split manner, unequal yaw forces acting on the vehicle are counteracted and are thus minimized or cancelled out. For example, if the restricted flow pressure paths instead corresponded to the same side of the vehicle, a fast apply could promote a bias across both axles of the vehicle which could cause instability of the vehicle during this braking event due to yaw forces acting on the vehicle.

To control the pressure exiting the conduits 416 and 434 from the auxiliary brake module 400, the solenoid actuated pump valves 420 and 436 are preferably controlled by the secondary ECU 401. The secondary ECU 401 is preferably included in the brake system 10 in case of a failure of the main ECU 22 which would not be able to control the auxiliary brake module 400. Thus, assisted braking can still be accomplished during a manual push through braking event with the secondary ECU 401 and the auxiliary brake module 400. As stated above, the solenoid actuated pump valves 420 and 436 are controlled by the secondary ECU 401 to obtain a desired fluid pressure exiting the conduits 416 and 434 from the auxiliary brake module 400. For example, a given electrical current is directed to the solenoid within the pump valve 420 to bias the pump valve 420 in a closed position preventing the flow of fluid therethrough. A pressure build up from the pump 408 in the conduit 412 will eventually exceed the force of the solenoid maintaining closure of the pump valve 420, thereby opening the pump valve 420. Once the pump valve 420 is open, fluid will be sent back to the inlet of the pump 408 via the conduit 422 until the pump valve 420 closes again. This cycle will repeat to maintain a relatively desired pressure relative to the current directed to the solenoid of the pump valve 420. The greater the electrical current sent to the pump valve 420, the greater the output pressure of the pump 408. The other pump valve 436 is controllable in the same manner with respect to controlling the pressure of the conduit 434.

The secondary ECU 401 controls the solenoid actuated pump valves 420 and 436 to a desired pressure based on the driver's demands. The driver's demands can be determined with the use of various sensors, such as for example the travel sensors 214 and 215 of the master cylinder 14. The secondary ECU 401 preferably receives signals from one or both of the travel sensors 214 and 215 of the master cylinder 14. Driver demand or intent can be determined by monitoring the travel sensors 214 and 215 as the input piston 102 moves in the housing of the master cylinder 14 caused by depression of the brake pedal 70 during a manual push through event. The auxiliary brake module 400 can be operated accordingly based on the travel sensor information since the driver's pedal travel demand is known. From previous knowledge from the main ECU 22 regarding the P-V (pressure-volume) characteristics of the wheel brakes and various components of the brake system 10, the secondary ECU 401 can control the auxiliary brake module 400 accordingly. For example, it may be known from previous data collection that for a given travel distance of the input piston 102, a certain pressure is generated in the circuit conduits 36 and 38. If it is known that the auxiliary brake module 400 should provide an added fluid volume by a predetermined ratio, for example ⅔ of the desired volume at a given pressure at the wheel brakes, the auxiliary brake module 400 can be operated to provide the necessary added volume increase. As stated above, this added volume of fluid from the auxiliary brake module 400 shortens the pedal travel length that the driver needs to initiate at the master cylinder 14 had the auxiliary brake module 400 not been included in the brake system 10.

The auxiliary brake module 400 may include separate conduits 424 and 440 in fluid communication with the reservoir 20 in case one of the circuits associated with one of the conduits 424 and 440 fails and starts leaking fluid. Under this situation, the pump 408 or 410 associated with the leaking circuit could run out of fluid at its intake such that the pump 408 or 410 injects air into the circuit and possibly the wheel brakes. Although that leaking circuit may not function properly, the pump 408 or 410 not associated with the leaking circuit would still function properly due to a separate connection with the reservoir 20, and thus braking of the vehicle can still be accomplished with just the one circuit (associated with the conduits 36 or 38). The leak may be detected by monitoring the correct operation of the motor 406.

Although use of the auxiliary brake module 400 was described above with respect to being used during a failure of one or more of the components of the brake system 10, such as during a manual push through event, the auxiliary brake module 400 could be triggered on during a non-failed braking event. For example, the auxiliary brake module 400 could be triggered during self-diagnostics.

If desired, the brake system 10 could be configured to operate even if the driver is not pressing on the brake pedal 70, and thus, no pressure can be generated from the master cylinder 14. For example, the auxiliary brake module 400 may be engaged due to a failed event of the brake system 10 during an autonomous driving/braking event. During a normal autonomous driving/braking event, the plunger assembly 18 can be operated to provide the desired braking control to the wheel brakes 12a, 12b, 12c, and 12d. However, if the main braking system 10 fails, such as an electrical power cut-off to the brake system 10 such that the plunger assembly 18 cannot be operated, the secondary ECU 401 can engage the auxiliary brake module 400 to provide pressure to the front and rear circuits via the conduits 416 and 434. To accomplish this, the brake system 10 would need to be configured to prevent fluid from flowing through the master cylinder 14 and into the reservoir 20. The auxiliary brake module 400 could be configured to operate the simulator test valve 29 to an energized closed position to prevent the flow of fluid through the now open compensation ports (passageways 138 and 148) of the master cylinder 14 to the reservoir 20. An additional valve (not shown) could be incorporated into the conduit 26 to prevent the flow of fluid through the passageway 158 and into the reservoir 20.

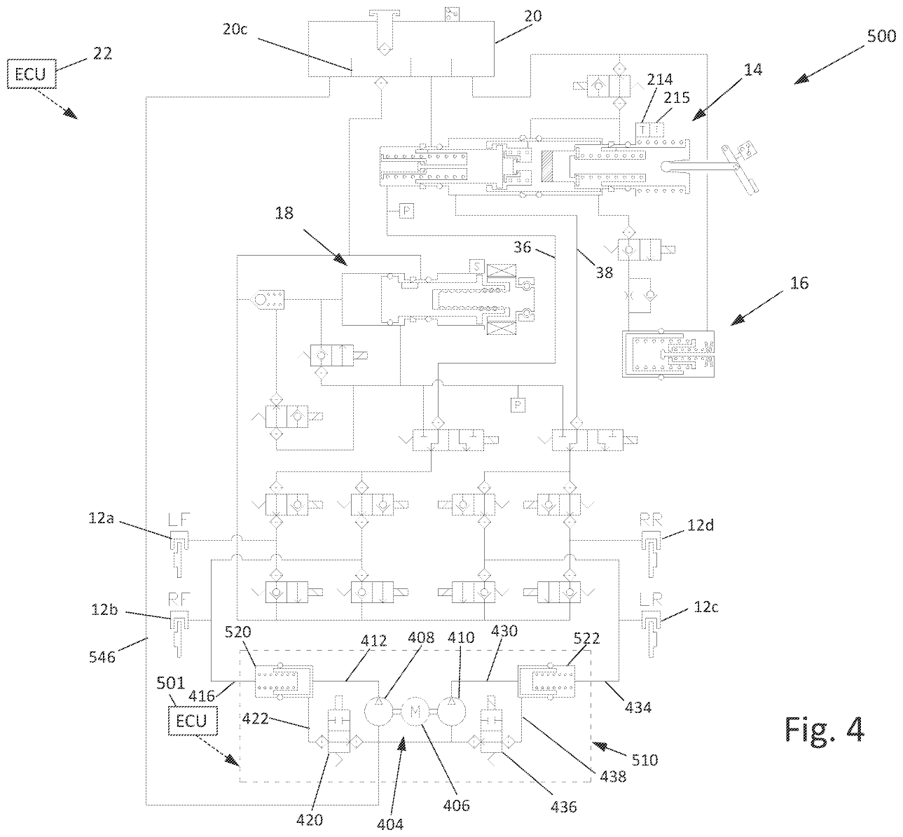

Although the brake system 10 functions sufficiently during a manual push through braking event, one disadvantage of the brake system 10 is that while the auxiliary brake module 400 can introduce a pressure increase (fluid added to the conduits 416 and 434), the auxiliary brake module 400 generally cannot remove fluid or relieve pressure at the wheel brakes 12a, 12b, 12c, and 12d. Fluid pressure is released when the master cylinder 14 is operated by the driver to its rest state such that pressure in the primary and secondary chambers 112 and 114 is vented to the reservoir 20. Assuming that the dump valves 52, 56, 60, and 64 are also inoperable during the manual push through braking event, such as due to a loss of electrical power or failure of the main ECU 22, fluid pressure cannot be released using these dump valves 52, 56, 60, and 64. However, there is illustrated in FIG. 4 a brake system, indicated generally at 500, that is capable of releasing pressure at the wheel brakes during a manual push through event

Referring now to FIG. 4, the brake system 500 is fairly similar in structure and function as the brake system 10 described above. As such, similarities between the brake systems 10 and 500 may not be discussed in duplication herein. In addition, similar structures and components of the brake system 500 will use the same reference numbers as in the brake system 10.

The brake system 500 includes an auxiliary brake module, indicated generally at 510. The auxiliary brake module 510 functions as a second source of pressurized fluid, such as under certain failed conditions of the brake system 500. As a secondary source of pressurized fluid, the auxiliary brake module 510 provides an added volume of fluid to the brake system 500 during a manual push through braking event. Additionally, the auxiliary brake module 510 can relieve pressure within the wheel brakes during a manual push through braking event. The auxiliary brake module 510 may be housed in a different block or unit remotely located from the remainder of the brake system 500, or may be housed integrally therewith. The auxiliary brake module 510 may further include a secondary ECU 501 (separate from the main ECU 22) for controlling the various valves and components of the secondary brake module 510. The secondary ECU 501 may also be in communication with the ECU 22. In a preferred embodiment, the secondary ECU 501 is also in communication with the travel sensors 214 and 215, as discussed above with respect to the brake system 10. Similar to the brake system 10, the brake system 500 includes the pump assembly 404 having the motor 406 and first and second pumps 408 and 410. The brake system 500 also includes the pump valves 420 and 436, corresponding to the first and second pumps 408 and 410, respectively.

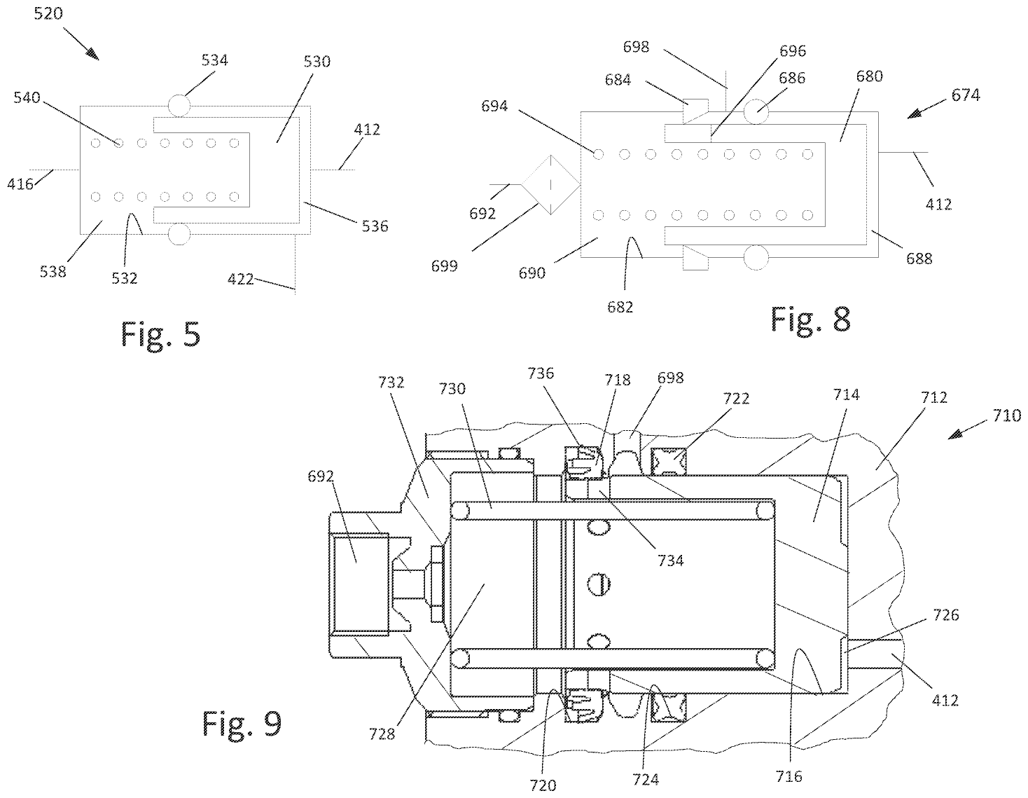

One of the differences between the brake systems 10 and 500 is that the brake system 500 includes first and second fluid separators 520 and 522 located within the conduits 416 and 434, respectively. It is noted that the brake system 500 does not include the check valves 414 and 432. The fluid separators 520 and 522 are essentially identical in structure in function. Thus, only the structure and function of the fluid separator 520 will be discussed in detail but it should be understood that the same description applies to the second fluid separator 522 as well. As shown in an enlarged schematic view in FIG. 5, the fluid separator 520 includes a cup shaped piston 530 slidably disposed in a single diameter bore 532 of a housing. A seal 534 is mounted in a groove formed in the housing and is sealingly engaged with the outer surface of the piston 530 as the piston 530 moves within the bore 532. The right-hand end of the piston 530, the seal 534, and the bore 532 define a first chamber 536 which is in fluid communication with the conduit 412 leading to the outlet of the pump 408. The left-hand end of the piston 530, the seal 534, and the bore 532 define a second chamber 538 which is in fluid communication with the conduit 416 leading to the wheel brakes 12a and 12b. The piston 530 is biased by a spring 540 in a rightward direction, as viewing FIG. 5. The configuration of the single diameter bore 532 and the piston 530 provide equal amounts of fluid flow into and out of the first and second chambers 536 and 538 during movement of the piston 530.

During an actuation of the auxiliary brake module 510, a pressure increase in the first chamber 536 caused by an increase pressure in the conduit 412 from the outlet of the pump 408 expands the first chamber 536. Assuming that the pressure in the conduit 416 is lower than the pressure within the conduit 412, the expansion of the first chamber 536 causes the piston 530 to move leftwardly, as viewing FIG. 5, thereby forcing fluid into the conduit 416.

The fluid separators 520 and 522 isolate the fluid within the auxiliary brake module 510 from the front circuit (associated with the wheel brakes 12a and 12b, the conduits 416 and 36, etc.) and the rear circuit (associated with the wheel brakes 12c and 12d, the conduits 434 and 38, etc.). Since the auxiliary brake module 510 is now isolated, the brake system 500 needs only one conduit 546 leading to the reservoir 20 compared to the two conduits 424 and 440 of the brake system 10. If a leak occurs in the auxiliary brake module 510, such as in the conduit 546, the auxiliary brake module 510 may not function properly due to air being introduced into the pumps 408 and 410, however, this introduced air will not be sent into the main brake system 500 due to the barrier function of the fluid separators 520 and 522. It is also noted that the reservoir 20 of the brake system 500 includes an additional interior wall 20c to isolate this auxiliary brake module fluid circuit from the other circuits. This interior wall 20c helps to assure that a leakage in one of the circuits will not deplete the reservoir fluid for the auxiliary brake module 510.

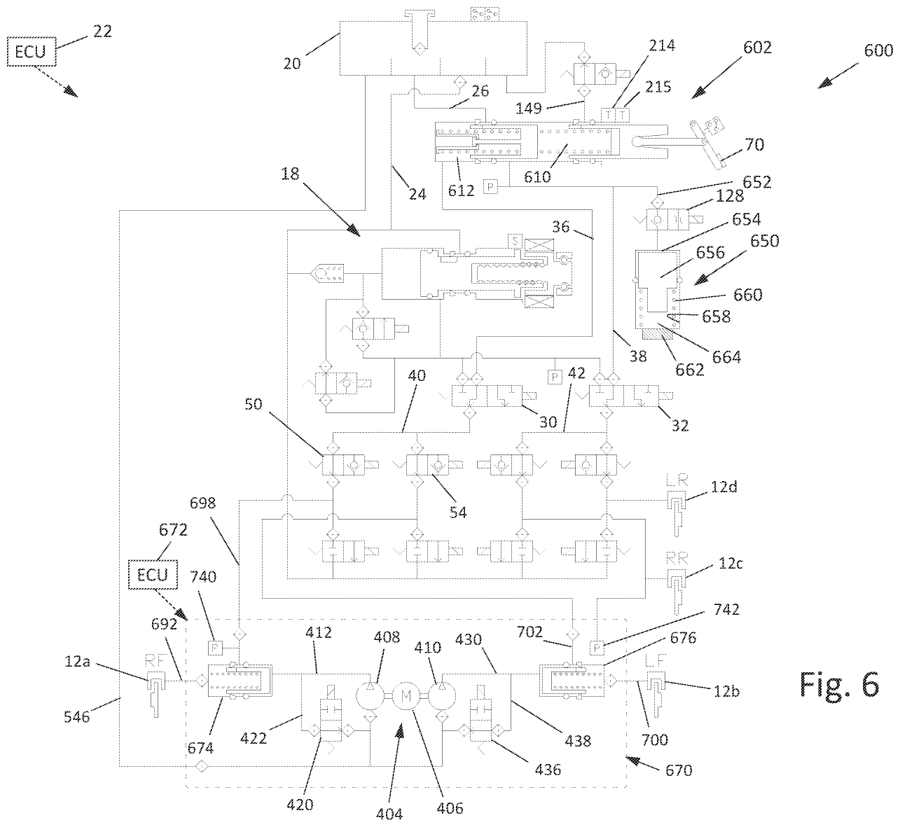

Referring now to FIG. 6, there is illustrated an embodiment of a brake system, indicated generally at 600 that is fairly similar in structure and function as the brake systems 10 and 500 described above. As such, similarities between the brake systems 10, 500, and 600 may not be discussed in duplication herein. In addition, similar structures and components of the brake system 600 will use the same reference numbers as in the brake systems 10 and 500.

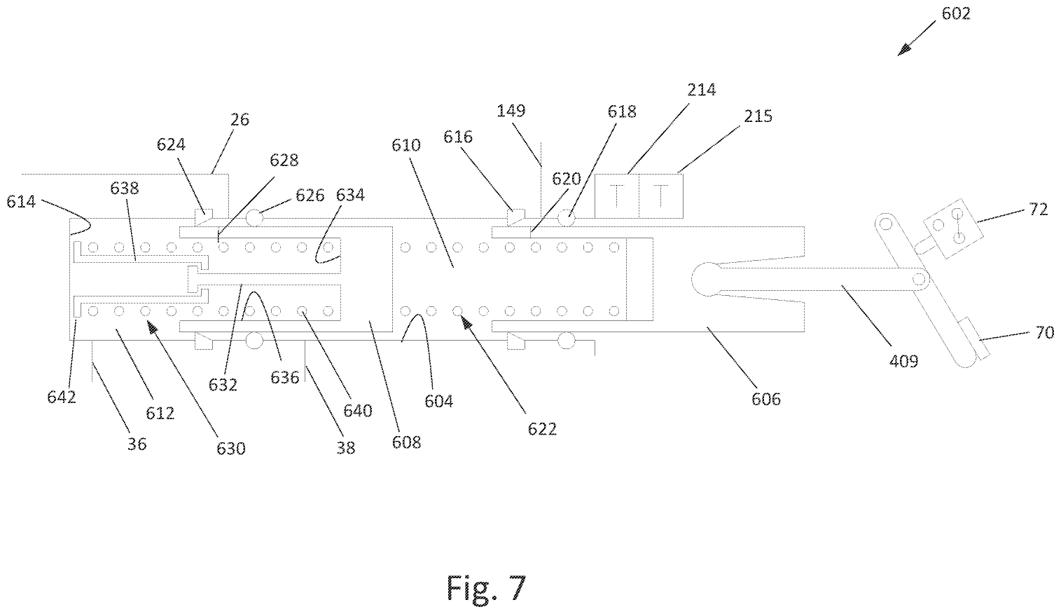

One of the differences between the brake system 600 and the preceding brake systems is that the brake system 600 utilizes a two piston master cylinder, indicated generally at 602, instead of a three piston design such as the master cylinder 14. Referring now to the enlarged view of the master cylinder 602 in FIG. 7, the master cylinder 602 includes a housing having a bore 604 formed therein for slidably receiving various cylindrical pistons and other components therein. Note that the housing is not specifically schematically shown in FIG. 7 but instead the walls of the bore 604 are illustrated. The housing may be formed as a single unit or include two or more separately formed portions coupled together. A primary piston 606 and a secondary piston 608 are slidably disposed within the bore 604. The primary piston 606 is connected with the brake pedal 70 via the linkage arm 409. Leftward movement of the primary piston 606 and the secondary piston 608 may cause, under certain conditions, a pressure increase within a primary chamber 610 and a secondary chamber 612, respectively, of the master cylinder 602. Various seals of the master cylinder 602 as well as the structure of the housing and the pistons 606 and 608 define the chambers 610 and 612. For example, the primary chamber 610 is generally defined between the primary piston 606 and the secondary piston 608. The secondary chamber 612 is generally defined between the secondary piston 608 and an end wall 614 of the housing formed by the bore 604.

As shown in FIG. 6, the primary chamber 610 of the master cylinder 602 is in fluid communication with the second isolation valve 32 via the conduit 38. Referring back to FIG. 7, an outer wall of the primary piston 606 is engaged with a lip seal 616 and a seal 618 mounted in grooves formed in the housing. One or more lateral passageways 620 are formed through a wall of the primary piston 606. The passageway 620 is located between the lip seal 616 and the seal 618 when the primary piston 606 is in its rest position, as shown in FIGS. 6 and 7. Note that in the rest position the lip seal 616 is to the left of the passageway 620, thereby permitting fluid communication between the primary chamber 610 and the reservoir 20 via the conduit 149. When the passageway 620 moves past the lip seal 616 such that it is to the left of the lip seal 616, fluid communication is cut off between the primary chamber 610 and the reservoir 20. Therefore, the cooperation between the passageway 620, the lip seal 616, and the conduit 149 function as a compensation port selectively permitting fluid communication between the primary chamber 610 and the reservoir 20.

The master cylinder 602 may include a primary spring arrangement, indicated generally at 622, disposed between the primary piston 606 and the secondary piston 608. This positional relationship helps to define the volume of the primary chamber 610 in its at rest state or generally uncompressed condition. Additionally, the primary spring assembly 622 biases the primary and secondary pistons 606 and 608 away from each other when the primary spring assembly 622 is compressed. The primary spring arrangement 622 may have any suitable configuration, such as a caged spring assembly or a simple coil spring, as shown.

As shown in FIG. 6, the secondary chamber 612 of the master cylinder 602 is in fluid communication with the first isolation valve 30 via the conduit 36. Referring back to FIG. 7, an outer wall of the secondary piston 608 is engaged with a lip seal 624 and a seal 626 mounted in grooves formed in the housing. One or more lateral passageways 628 are formed through a wall of the secondary piston 608. The passageway 628 is located between the lip seal 624 and the seal 626 when the secondary piston 608 is in its rest position, as shown in FIGS. 6 and 7. Note that in the rest position the lip seal 624 is to the left of the passageway 628, thereby permitting fluid communication between the secondary chamber 612 and the reservoir 20 via the conduit 26. When the passageway 628 moves past the lip seal 624 such that it is to the left of the lip seal 624, fluid communication is cut off between the secondary chamber 612 and the reservoir 20. Therefore, the cooperation between the passageway 628, the lip seal 624, and the conduit 26 function as a compensation port selectively permitting fluid communication between the secondary chamber 612 and the reservoir 20.

The master cylinder 14 may include a secondary spring arrangement, indicated generally at 630, disposed between the secondary piston 608 and the end wall 614 of the housing of the master cylinder 602. The secondary spring arrangement 630 positions the secondary piston 608 at a desired placement relative to the end wall 614 when the master cylinder 602 is assembled. This positional relationship helps to define the volume of the secondary chamber 612 in its at rest state or generally uncompressed condition. Additionally, the secondary spring assembly 630 biases the secondary piston 608 in a rightward direction, as viewing FIG. 7, when the secondary spring assembly 630 is compressed. The secondary spring arrangement 630 may have any suitable configuration, such as a caged spring assembly. For example, the secondary spring assembly 630 may include a stem 632 attached to a bottom wall 634 of a bore 636 formed in the secondary piston 608. The stem 632 engages with a tubular retainer 638 which is slidably mounted and captured on the stem 632. A coil spring 640 is disposed around the stem 632 and the retainer 638. One end of the coil spring 640 engages with the bottom wall 634 of the bore 636. The other end of the coil spring 640 engages with an outwardly extending flange 642 of the retainer 638.

One advantage of the design of the two piston master cylinder 602 over the design of the three piston master cylinder 14 is the lower cost of the two piston design due to fewer components and simpler construction. Additionally, the two piston master cylinder design may be easier to package within the vehicle due to its smaller size compared to the three piston design. Another advantage of the master cylinder 602 is the possibility of a lower pedal force required due in part to the absence of a caged spring assembly design of the primary spring 622. However, during a manual push through event, a greater travel may be necessary due to the requirement of the compensation ports needing to be first closed. The three piston master cylinder design may also require additional seal friction to overcome due to the greater amount of seals compared to a two piston master cylinder design. However, the three piston design may have the advantage of having no or less fluid loss during a manual push through event since all of the volume of fluid in the primary chamber may be used in the three position design. Contrary, if the manual push through event is initiated after the driver has moved the primary piston in the two piston master cylinder design, fluid diverted into the pedal simulator is now not available. Of course, the design and size of the chambers of the master cylinders can be configured to avoid or minimize this issue.

Another difference of the brake system 600 is the configuration of a pedal simulator 650. Although the pedal simulator 650 performs the same function as the pedal simulator 16 of the brake system 10 to provide driver pedal feel feedback, in the brake system 600, the primary chamber 610 of the master cylinder 602 is in selective fluid communication with the pedal simulator 650 via a conduit 652 which is in fluid communication with the conduit 38. Leftward movement of the primary piston 606 caused by the driver depressing the brake pedal 70 will pressurize the primary chamber 610 causing fluid to flow into the pedal simulator 650 via the conduits 38 and 652.

The pedal simulator 650 can be any suitable structure which provides a feedback force to the driver's foot via the brake pedal 70 when depressed. The pedal simulator 650 may include movable components which mimic the feedback force from a conventional vacuum assist hydraulic brake system. For example, as fluid is diverted into the pedal simulator 650, a simulation pressure chamber 654 defined within the pedal simulator 650 will expand causing movement of a piston 656 within the pedal simulator 650. Note that in FIG. 6, the simulation pressure chamber 654 is shown generally at its smallest volume such that the position of the piston 656 almost completely minimizes the volume of the simulation pressure chamber 654. The piston 656 is slidably disposed in a bore 658 formed in a housing of the pedal simulator 650. Movement of the piston 656 compresses a spring assembly, schematically represented as a spring 660. The compression of the spring 660 provides the feedback force to the driver of the vehicle. The spring 660 of the pedal simulator 650 can include any number and types of spring members as desired. For example, the spring 660 may include a combination of low rate and high rate spring elements to provide a non-linear force feedback. The pedal simulator 650 may also include a compressible elastomeric pad 662 which engages with an end of the piston 656 when the piston 656 approaches its end of travel position, thereby providing a desired feedback force different from that provided solely by the spring 660. The spring 660 of the pedal simulator 16 may be housed within an air-filled chamber 664 vented to atmosphere. Alternatively, the spring 660 may be housed in a fluid chamber which may optionally be in fluid communication with the reservoir 20 in a similar arrangement as the pedal simulator 16 of the brake system 10.

The brake system 600 includes an auxiliary brake module, indicated generally at 670. Similar to the auxiliary brake module 400, the auxiliary brake module 670 functions as a second source of pressurized fluid, such as under certain failed conditions of the brake system 600. As a secondary source of pressurized fluid, the auxiliary brake module 670 provides an added volume of fluid to the brake system 600 during a manual push through braking event. Additionally, the auxiliary brake module 600 can relieve pressure within the wheel brakes during a manual push through braking event. The auxiliary brake module 670 may be housed in a different block or unit remotely located from the remainder of the brake system 600, or may be housed integrally therewith. The auxiliary brake module 670 may further include a secondary ECU 672 (separate from the main ECU 22) for controlling the various valves and components of the secondary brake module 670. The secondary ECU 672 may also be in communication with the main ECU 22. In a preferred embodiment, the secondary ECU 672 is also in communication with the travel sensors 214 and 215, as discussed above with respect to the brake system 10. Similar to the brake systems 10 and 500, the brake system 600 includes the pump assembly 404 having the motor 406 and first and second pumps 408 and 410. The first and second pumps 408 and 410 have output conduits 412 and 430, respectively, as well as input conduits 422 and 438, respectively. The auxiliary brake module 670 further includes the pump valves 420 and 436, corresponding to the first and second pumps 408 and 410, respectively. The inlet conduits 422 and 438 are in fluid communication with the single hose or conduit 546 in fluid communication with the reservoir 20.

It is noted that the brake system 600 is configured as a vertically split system such that the conduit 36 is associated with the front wheel brakes, and the conduit 38 is associated with the rear wheel brakes, as is the brake system 500. However, the wheel brake designation for the brake system 600, is slightly different from the brake system 10 as well as is the configuration of the auxiliary brake module 670, as will be explained below. For the brake system 600, the wheel brake 12a may be associated with the right front wheel of the vehicle in which the brake system 600 is installed. The wheel brake 12b may be associated with the left front wheel. The wheel brake 12c may be is associated with the right rear wheel. The wheel brake 12d may be associated with the left rear wheel.

Another difference between the brake systems 500 and 600 is that the brake system 600 includes differently configured first and second fluid separators 674 and 676. The fluid separators 674 and 676 have a dual seal design compared to the single seal design of the fluid separators 520 and 522. The fluid separators 674 and 676 essentially perform the same function as the fluid separators 520 and 522 in that they isolate the fluid within the auxiliary brake module 670. The fluid separators 674 and 676 are essentially identical in structure in function. Thus, only the structure and function of the fluid separator 674 will be discussed in detail with respect to FIG. 8 but it should be understood that the same description applies to the second fluid separator 676 as well.

As shown in an enlarged schematic view in FIG. 8, the fluid separator 674 includes a cup shaped piston 680 slidably disposed in a single diameter bore 682 of a housing. A first seal 684 is mounted in a groove formed in the housing and is sealingly engaged with the outer surface of the piston 680 as the piston 680 moves within the bore 682. A second seal 686 is mounted in a groove formed in the housing and is sealingly engaged with the outer surface of the piston 680 as the piston 680 moves within the bore 682. The right-hand end of the piston 680, the seal 686, and the bore 682 define a first chamber 688 which is in fluid communication with the conduit 412 leading to the outlet of the pump 408. The left-hand end of the piston 680, the seal 684, and the bore 682 generally define a second chamber 690 which is in fluid communication with a conduit 692 leading to the wheel brake 12a. The piston 680 is biased by a spring 694 in a rightward direction, as viewing FIG. 8.

A passageway(s) 696 is formed through the piston 680. The passageway 696 provides fluid communication between the second chamber 690 and a conduit 698 when the fluid separator 674 is in its rest position, as shown in FIGS. 6 and 8. In this position, the wheel brake 12a is in fluid communication with the isolation valve 30 via the conduit 692, the second chamber 690, the passageway 696, and the conduit 698 which is in fluid communication with the conduit 40 through the apply valve 50. Thus, during normal braking, pressurized fluid from the conduit 40 is diverted to the wheel brake 12a via the conduit 698.

The fluid separator 674 may also include a fluid filter, as shown schematically at 699, for filtering out particulate matter and preventing this particulate matter from scratching, damaging, or preventing proper operation of the seal 684. Of course, the use of fluid filters (as shown schematically similar as the filter 699 in FIG. 8) can be used throughout the various brake systems described herein.

As stated above, the second fluid separator 676 is similar in design as the first fluid separator 674. Thus, the first fluid chamber of the fluid separator 676 is in fluid communication with the conduit 430, the second fluid chamber is in fluid communication with a conduit 700 connected to the wheel brake 12b. In the rest position, the passageway of the piston of the second fluid separator 676 is in fluid communication with a conduit 702 in fluid communication with the conduit 40 through the apply valve 54. Thus, during normal braking, pressurized fluid from the conduit 40 is diverted to the wheel brake 12b via the conduit 702.

When the auxiliary brake module 670 is activated, such as during a failed condition of the brake system 10 in which the plunger assembly 18 is inoperative, the secondary ECU 672 actuates the motor 406 to engage the pumps 408 and 410 to provide pressurized fluid to the conduits 412 and 430, respectively. The pressure rise of the conduits 412 and 430 causes movement of the pistons within the fluid separators 674 and 676, thereby transferring the pressure therethrough causing a pressure rise within the conduits 692 and 700 to actuate the front wheel brakes 12a and 12b. Similar to the preceding auxiliary brake modules, the pump valves 420 and 436 of the auxiliary brake module 670 can be controlled to regulate the output pressure at the conduits 412 and 430. It is noted that unlike the brake system 500, the auxiliary brake module 670 of the brake system 600 does not provide pressure from the auxiliary brake module 670 to the rear wheel brakes 12c and 12d via a path. Instead, the pressure downstream from the fluid separators 674 and 676 is fed directly to the wheel brakes 12a and 12b, respectively, once the pistons of the fluid separators have moved a sufficient distance closing of the respective passageways (696) formed in the pistons (680).

It is also noted that the fluid separators 674 and 676 are preferably designed to permit a higher pressure fluid within the conduits 698 and 702 to be directed through the fluid separators 674 and 676 to the wheel brakes 12a and 12b should the pressure from the pumps 408 and 410 be less than the pressure from the conduits 698 and 702 such as by a manual push through brake apply. As shown in FIG. 8, this can be accomplished via the lip seal 684. Higher pressure fluid from the conduit 698 can flow past the lip seal 684.

The configuration of the brake system 600 permits the auxiliary brake module 670 to provide a higher pressure at the wheel brakes 12a and 12b than what the driver may want on all four brakes, as compared to the brake system 500 of FIG. 4 which is used to assist manual push through by reducing pedal travel by generally adding fluid volume to the system. Thus, the brake system 600 can be used for autonomous braking (or additional braking force as needed) to cause braking pressure at the wheel brakes 12a and 12b even if the driver is not pressing on the brake pedal 70. Although the brake system 600 could be configured to include additional fluid separators (not shown) on the rear circuit to permit the auxiliary brake module 670 to also control the rear brakes 12c and 12d, it may be desirable to use the electric parking brakes 810 and 812 (as discussed below with respect to the brake system 800) instead, thereby permitting control of all four wheel brakes.

There is illustrated in FIG. 9 a more detailed illustration of a fluid separator, indicated generally at 710, which may be used for the fluid separator 674 in the brake system 600, for example. The fluid separator 710 is mounted within a housing 712, such as a metallic block or housing containing the components of the auxiliary brake module (670) in which the fluid separator 710 is housed in. The fluid separator 710 includes a cup shaped piston 714 slidably disposed in a bore 716 of the housing 712. A first seal 718 is mounted in a groove 720 formed in the housing 712 and is sealingly engaged with the outer surface of the piston 714 as the piston 714 moves within the bore 716. A second seal 722 is mounted in a groove 724 formed in the housing 712 and is sealingly engaged with the outer surface of the piston 714 as the piston 714 moves within the bore 716. The right-hand end of the piston 714, the seal 722, and the bore 716 define a first chamber 726 which is in fluid communication with the conduit 412 leading to the outlet of the pump 408, for example. The left-hand end of the piston 714, the seal 718, and the bore 716 generally define a second chamber 728 which is in fluid communication with the conduit 692 leading to the wheel brake 12a, for example. The piston 714 is biased by a spring 730 in a rightward direction, as viewing FIG. 9. For ease of installation, a separate threaded retainer 732 may be threadably mounted in the bore 716 to help contain the spring 730 as well as form a connection for the conduit 692 which may be in the form of an external hose or line. One of more passageways is 734 is formed through the piston 714. The passageway 734 provides fluid communication between the second chamber 728 and the conduit 698 when the fluid separator 710 is in its rest position, as shown in FIG. 9.

The fluid separator 710 is designed to permit a higher pressure fluid within the conduit 698 to be directed through the fluid separator 710 to the wheel brakes 12a, for example, as described above with respect to the schematic fluid separator 674. As shown in FIG. 8, this can be accomplished via the seal 718. The seal 718 includes an outer annular flange 736 which may be flexed radially inwardly when a higher pressure exists from conduit 698 compared to the pressure within the second chamber 728. Higher pressure fluid from the conduit 698 can flow past the radially inwardly directed flange 736 in the groove 720 to the second chamber 728.

There is also shown in FIG. 6 optional pressure transducers or pressure sensors 740 and 742 which may be used in any of the above brake systems described herein. The pressure sensors 740 and 742 may be located within the housing of the auxiliary brake module 670. The pressure sensors 740 and 742 may be connected to the secondary ECU 672. During a manual push through event wherein the auxiliary brake module 670 is utilized, the readings from the pressure sensors 740 and 742 correspond to the pressure from the master cylinder 602 via the conduits 36, 40 and 38, 42 which may be indicative of the driver's intent as the driver is applying a force to the brake pedal 70. The pressure sensor 740 generally senses the pressure directed to the front wheel brakes 12a and 12b, and the pressure sensor 742 generally senses the pressure directed to the rear brakes 12c and 12d. Instead of, or in addition to the information from the travel sensors 214 and 215 of the master cylinder 602, the secondary ECU 672 may use the information from the pressure sensors 740 and 742 to control the auxiliary brake module 670 indicative of the driver's intent.

If desired, the pressure sensors may be connected to both the main ECU 22 and the secondary ECU 672. During normal braking, the pressure sensor 740 generally senses the pressure directed to the front wheel brakes 12a and 12b, and the pressure sensor 742 generally senses the pressure directed to the rear brakes 12c and 12d. The main ECU 22 may use the information from the pressure sensors 740 and 742 to control the plunger assembly 18 although the pressure readings are generally not used to determine the driver's intent.

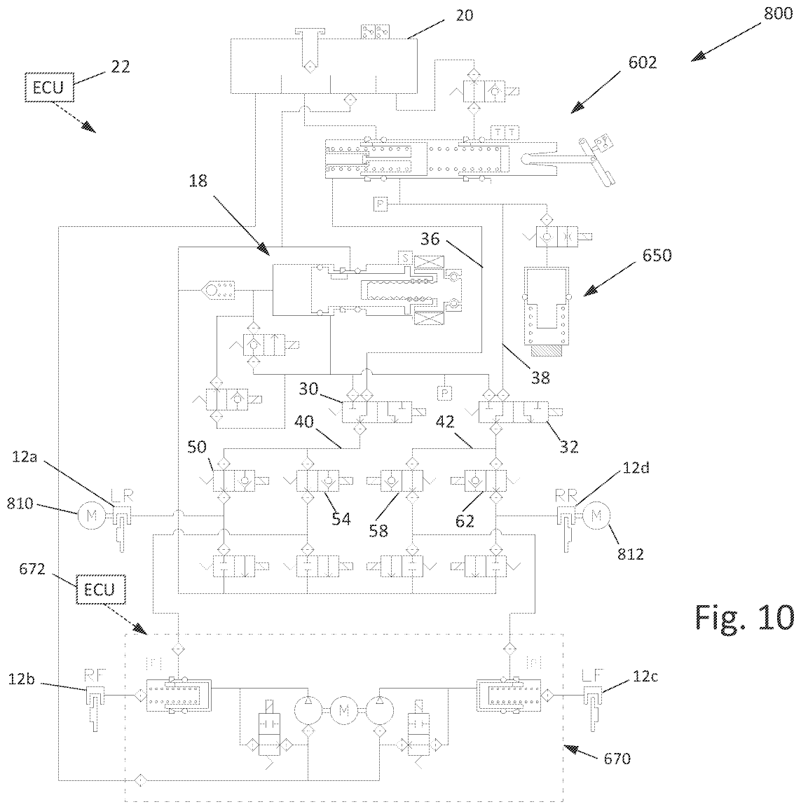

Referring now to FIG. 10, there is illustrated an embodiment of a brake system, indicated generally at 800, that is fairly similar in structure and function as the brake systems 10 and 600 described above. As such, similarities between the preceding brake systems may not be discussed in duplication herein. In addition, similar structures and components of the brake system 800 will use the same reference numbers as in the preceding brake systems.

One of the differences between the brake system 800 and the brake system 600 is that the brake system 800 is configured as a diagonally split brake system. As an example, the wheel brake 12a may be associated with the left rear wheel of the vehicle in which the brake system 800 is installed. The wheel brake 12b may be associated with the right front wheel. The wheel brake 12c may be associated with the left front wheel. The wheel brake 12d may be associated with the right rear wheel. As shown in FIG. 10, the conduit 36 is in fluid communication with the conduit 40 through the isolation valve 30. The conduit 40 is fluid communication with the wheel brakes 12a and 12b via the apply valves 50 and 54. The conduit 38 is in fluid communication with the conduit 42 through the isolation valve 32. The conduit 42 is in fluid communication with the wheel brakes 12c and 12d. It is noted that although the brake system 800 is configured as a diagonally split brake system relative to the master cylinder 602, the auxiliary brake module 670 provides pressure to the front wheel brakes 12b and 12c.

Another difference of the brake system 800 is the inclusion of electric motorized parking brakes 810 and 812. In the brake system 800 shown, the parking brake 810 is associated with the left rear wheel, while the parking brake 812 is associated with the right rear wheel. The parking brakes 810 and 812 can be any suitable mechanism for applying a braking force to a wheel. For example, the parking brakes 810 and 812 could include an electric motorized actuator connected to a brake pad for applying a frictional braking force to a rotor or drum connected to the wheel. The electrical motors of the parking brakes 810 and 812 are preferably controllable by one or both of the ECUs 22 and 672 for adding braking force to the associated wheel during a failed condition, such as for example, under a manual push through event. It should be understood that any of the brake systems described herein may include such parking brakes connected to the main or secondary ECUs, and any number of wheels may include such controllable parking brakes.

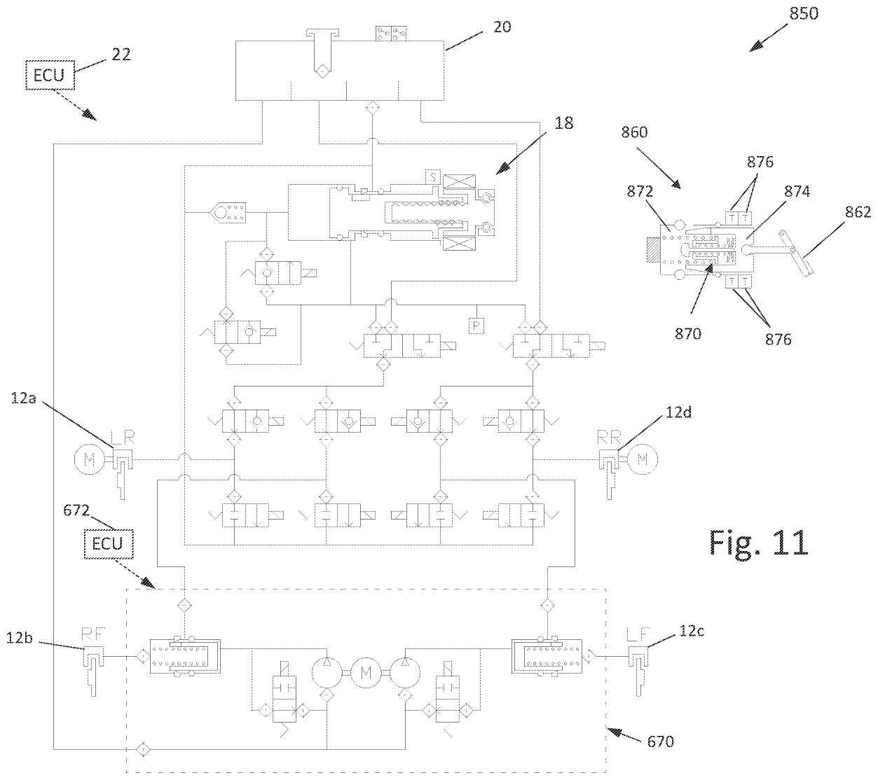

Referring now to FIG. 11, there is illustrated an embodiment of a brake system, indicated generally at 900, that is fairly similar in structure and function as the brake systems 10 and 500 described above. As such, similarities between the preceding brake systems may not be discussed in duplication herein. In addition, similar structures and components of the brake system 850 will use the same reference numbers as in the preceding brake systems.

One of the differences between the brake system 850 and the brake system 800 is that the brake system 850 may be configured as an autonomous brake system. As such, the brake system 850 could be configured to eliminate the manually operated brake pedal, the master cylinder, and the pedal simulator. Thus, the brake system 850 may not receive any input from a driver for the vehicle but is controlled by the main ECU and/or the secondary ECU during normal braking as well as under failed conditions (such as by control of the auxiliary brake module 670). Alternatively, the brake system 850 could be configured as a “brake-by-wire” system such that the brake system 850 does receive input from a driver of the vehicle via a remote pedal simulator, indicated generally at 860. The pedal simulator 860 is not connected hydraulically to the brake system 850. Instead, the pedal simulator 860 provides a force feedback to the driver as the driver depresses a brake pedal 862 and is electrically connected to the main ECU 22 and/or the secondary ECU 672 for providing information of the driver's intentions. The pedal simulator 860 includes a spring assembly, indicated generally at 870, housed in an air-filled chamber 872. A piston 874, which is connected to the brake pedal 862, pushes against the spring assembly 870 during operation of the pedal simulator 860 as the driver depresses the brake pedal 862. The pedal simulator 860 may include a plurality of redundant travel sensors 876. Each of the travel sensors 876 produces a signal that is indicative of the length of travel of the piston 874 and provides the signal to one or both of the ECUs 22 and 672. The travel sensors 876 may detect the rate of travel of the piston 874 as well. In the illustrated embodiment shown in FIG. 11, the pedal simulator 860 includes four travel sensors 876 such that two of the travel sensors 876 communicate with the main ECU 22, and the other two sensors 876 communicate with the secondary ECU 672 for controlling the auxiliary brake module 670.

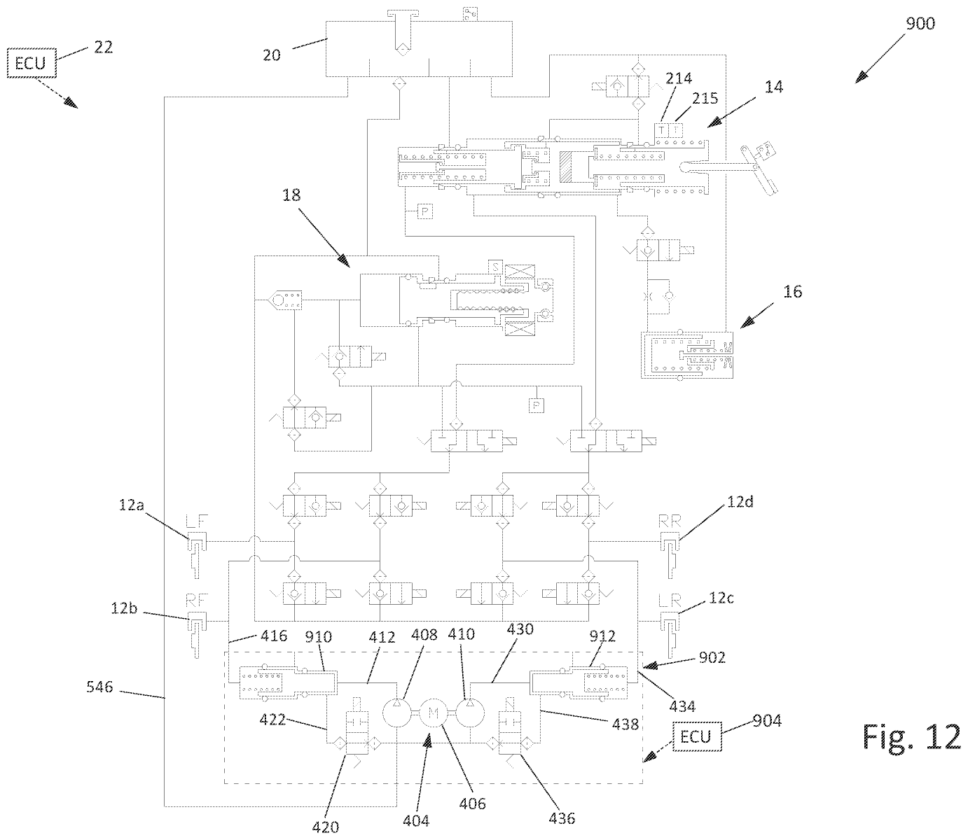

Referring now to FIG. 12, there is illustrated an embodiment of a brake system, indicated generally at 900 that is fairly similar in structure and function as the brake systems 10 and 500 described above. As such, similarities between the preceding brake systems may not be discussed in duplication herein. In addition, similar structures and components of the brake system 900 will use the same reference numbers as in the preceding brake systems.

The brake system 900 includes an auxiliary brake module, indicated generally at 902. The auxiliary brake module 902 functions as a second source of pressurized fluid, such as under certain failed conditions of the brake system 900. As a secondary source of pressurized fluid, the auxiliary brake module 902 provides an added volume of fluid to the brake system 900 during a manual push through braking event. Additionally, the auxiliary brake module 902 can relieve pressure within the wheel brakes during a manual push through braking event but generally cannot remove fluid other than what the auxiliary brake module contributes into the brake system 900. The auxiliary brake module 902 may be housed in a different block or unit remotely located from the remainder of the brake system 900, or may be housed integrally therewith. The auxiliary brake module 902 may further include a secondary ECU 904 (separate from the main ECU 22) for controlling the various valves and components of the secondary brake module 902. The secondary ECU 904 may also be in communication with the ECU 22. In a preferred embodiment, the secondary ECU 904 is also in communication with the travel sensors 214 and 215, as discussed above with respect to the brake system 10.

Similar to the auxiliary brake module 400 of the brake system 10, the auxiliary brake module 902 of the brake system 900 includes the pump assembly 404 having the motor 406 and first and second pumps 408 and 410. The auxiliary brake module 902 also includes the pump valves 420 and 436, corresponding to the first and second pumps 408 and 410, respectively. The outlet of the pump 408 is in fluid communication with the conduit 412, while the inlet of the pump 408 is in fluid communication with the conduit 422 and the pump valve 420. The outlet of the pump 410 is in fluid communication with the conduit 430, while the inlet of the pump 410 is in fluid communication with the conduit 438 and the pump valve 436.

One of the differences between the brake systems 500 and 900 is that the fluid separators 520 and 522 are replaced with volume intensifiers or flow intensifiers 910 and 912. The flow intensifiers 910 and 912 still perform the same function of isolating the fluid within the auxiliary brake module 902 from the front circuit (wheel brakes 12a and 12b) and the rear circuit (wheel brakes 12c and 12d). Similarly, only one fluid conduit 546 is necessary to connect the reservoir 20 to the inlet of the pumps 408 and 410 much the same as the brake system 500. However, the flow intensifiers 910 and 912 provide the additional advantage of increasing the volume of fluid exiting the flow intensifiers 910 and 912 towards the wheel brakes compared to the volume of fluid entering the flow intensifiers 910 and 912 from the outlets of the pumps 408 and 410.

The flow intensifiers 910 and 912 may be any suitable volume intensifier which increases the volume of fluid exiting the flow intensifier compared to the volume of fluid entering the flow intensifier. The flow intensifiers 910 and 912 are essentially identical in structure in function. Thus, only the structure and function of the flow intensifier 910 will be discussed in detail but it should be understood that the same description applies to the second flow intensifier 912 as well.

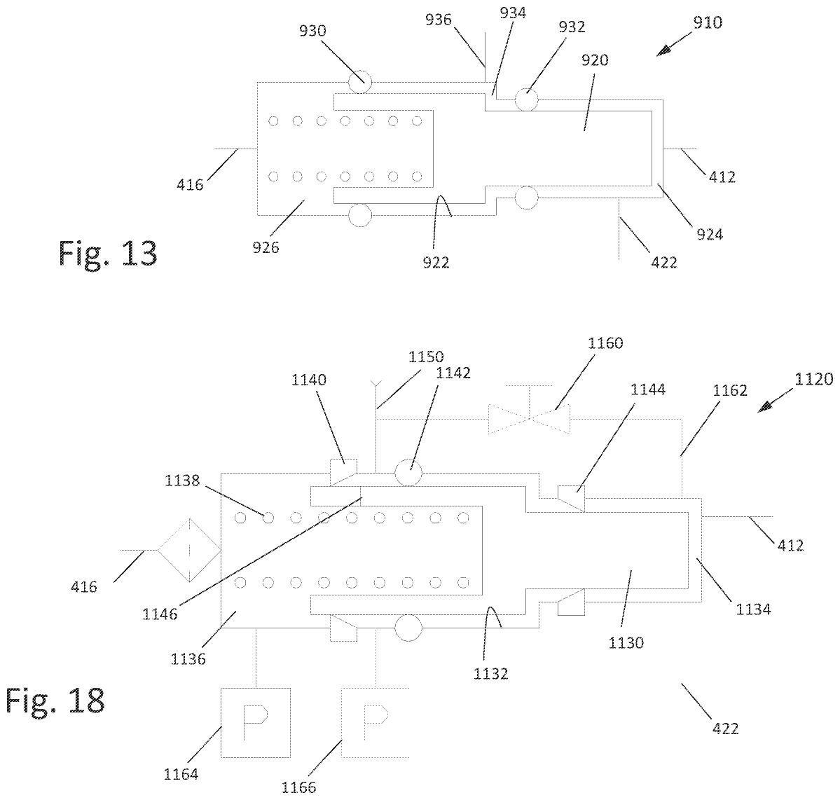

FIG. 13 is an enlarged schematic view of the flow intensifier 910. In the embodiment shown, the flow intensifier 910 includes a stepped piston 920 disposed in a multi-stepped bore 922 of a housing defining an inlet chamber 924 and an outlet chamber 926. A spring 928 biases the piston 920 within the housing towards the rightward direction, as viewing FIG. 13. The effective hydraulic areas acting on the chambers 924 and 926 are such that a greater amount of fluid will be displaced out through the conduit 416 (leading to the wheel brakes 12a and 12b), than entering the inlet chamber 924 via the conduit 412 from the first pump 408. The flow intensifier 910 may be designed with any suitable ratio of volume entering versus exiting the flow intensifier 910. For example, the flow intensifier 910 could be configured such that for every 1.0 cm³ of fluid entering the inlet chamber 924, 2.0 cm³ of fluid exits the outlet chamber 926. A suitable pump structure for the pumps 408 and 410 are generally low flow but high pressure output style pumps due to the reduced flow requirements because of the addition of the flow intensifiers 910 and 912 into the brake system 900.

The flow intensifier 910 further includes a first seal 930 engaged with a larger diameter portion of the piston 920. The flow intensifier 910 includes a second seal 932 engaged with a smaller diameter portion of the piston 920. A cavity 934 is generally defined between the first and second seals 930 and 932, and the outer surface of the piston 920 and the bore 922 and is preferably vented to atmosphere, such as through a passageway 936. Thus, the cavity 934 does not include fluid therein.

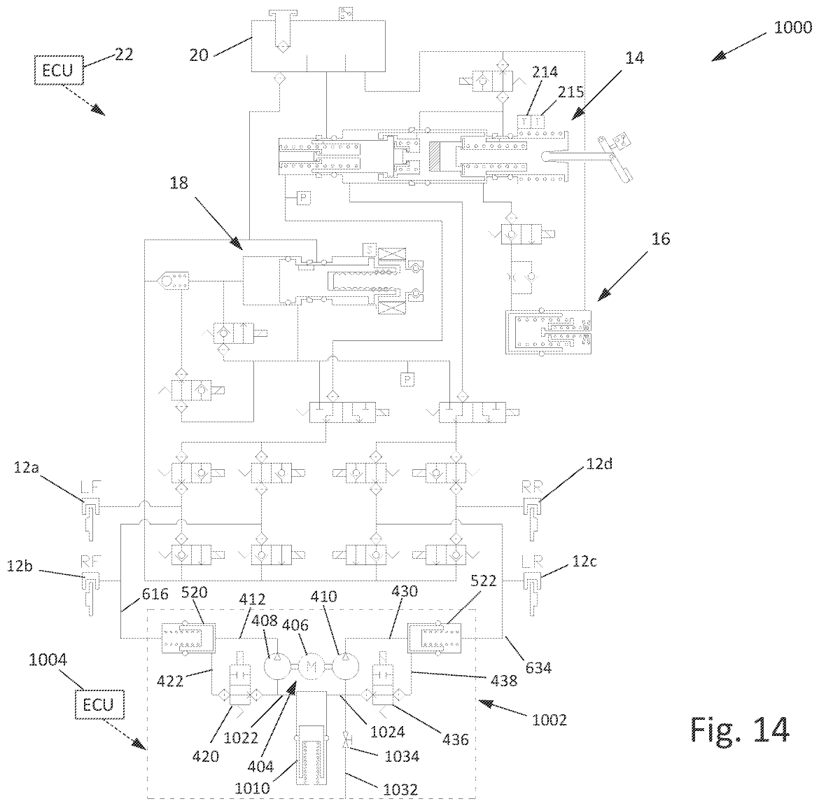

Referring now to FIG. 14, there is illustrated an alternate embodiment of a brake system, indicated generally at 1000, that is fairly similar in structure and function as the brake systems 10 and 500 described above. As such, similarities between the brake systems 10, 500, and 1000 may not be discussed in duplication herein. In addition, similar structures and components of the brake system 1000 will use the same reference numbers as in the brake systems 10 and 500. The brake system 1000 includes the three piston master cylinder 14, the pedal simulator 16, the plunger assembly 18, the reservoir 20, and the main ECU 22.

The brake system 1000 includes an auxiliary brake module, indicated generally at 1002. The auxiliary brake module 1002 functions as a second source of pressurized fluid, such as under certain failed conditions of the brake system 1000. As a secondary source of pressurized fluid, the auxiliary brake module 1002 provides an added volume of fluid to the brake system 1000 during a manual push through braking event. The auxiliary brake module 1002 may be housed in a different block or unit remotely located from the remainder of the brake system 1000, or may be housed integrally therewith. The auxiliary brake module 1002 may further include a secondary ECU 1004 (separate from the main ECU 22) for controlling the various valves and components of the secondary brake module 1002. The secondary ECU 1004 may also be in communication with the main ECU 22. In a preferred embodiment, the secondary ECU 1004 is also in communication with the travel sensors 214 and 215, as discussed above with respect to the brake system 10.

Similar to the brake systems 10 and 500, the auxiliary brake module 1002 of the brake system 1000 includes the pump assembly 404 having the motor 406 and first and second pumps 408 and 410. The auxiliary brake module 1002 also includes the pump valves 420 and 436, corresponding to the first and second pumps 408 and 410, respectively. The outlet of the pump 408 is in fluid communication with the conduit 412, while the inlet of the pump 408 is in fluid communication with the conduit 422 and the pump valve 420. The outlet of the pump 410 is in fluid communication with the conduit 430, while the inlet of the pump 410 is in fluid communication with the conduit 438 and the pump valve 436. The auxiliary brake module 1002 also includes the fluid separators 520 and 522 similar to the brake system 500.

One of the differences between the brake systems 500 and 1000 is that the brake system 1000 uses a low pressure accumulator 1010 instead of utilizing the conduit 546 to obtain fluid from the reservoir 20. Depending on the length of the conduit 546, the hose or piping can be relatively expensive given that the conduit 546 needs to have the required internal diameter to supply a sudden intake of fluid to the pumps 408 and 410 especially during cold weather environments. The low pressure accumulator 1010 provides a source of fluid at a relatively low pressure, such as for example, less than 1 bar above atmospheric pressure. The low pressure accumulator 1010 can be configured to hold any desirable volume of fluid necessary for proper operation. If desired, the low pressure accumulator 1010 could be configured to contain enough brake fluid to assure that during operation of the auxiliary brake module 1002 the wheel brakes 12a, 12b, 12c, and 12d can be provided with enough fluid for maximum braking power (and fluid capacity) at the calipers of the wheel brakes. However, this is generally not necessary as the driver is also providing a source of pressurized fluid during a manual push-through event via the master cylinder 14. The low pressure accumulator 1010 can have any suitable structure.

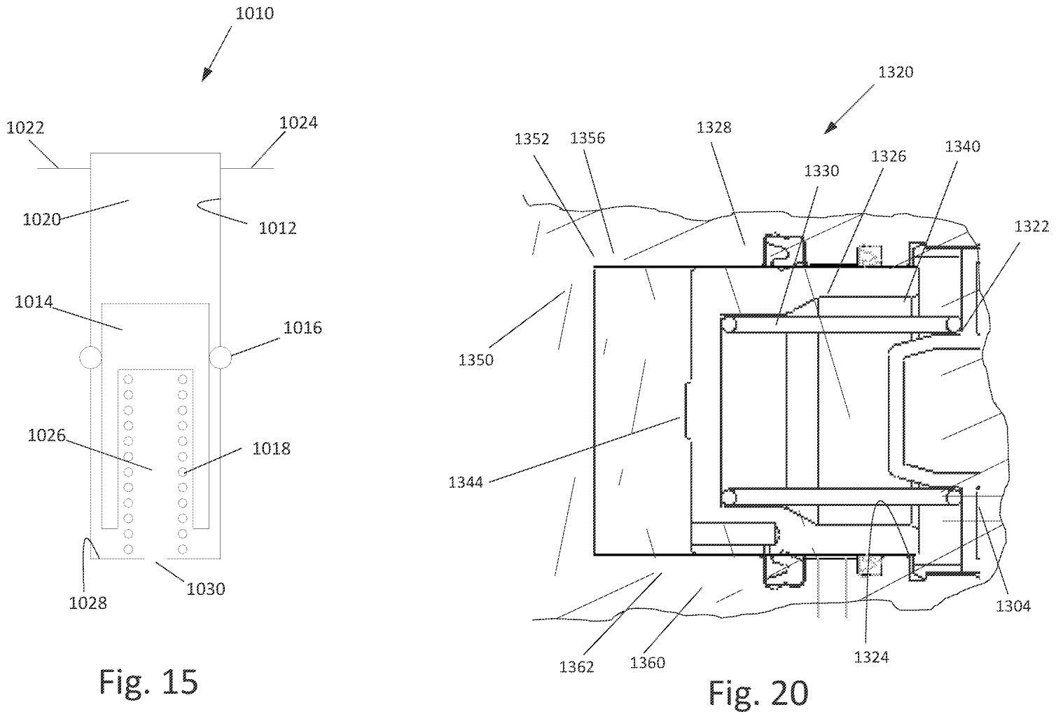

Referring to the enlarged view of the low pressure accumulator 1010 in FIG. 15, the low pressure accumulator 1010 includes a bore 1012 formed in the housing of the low pressure accumulator 1010. A piston 1014 is slidably disposed in the bore 1012 and is sealingly engaged with an inner wall of the bore 1012 by a seal 1016. A spring 1018 biases the piston 1014 upward, as viewing FIG. 15, such that upward motion of the piston 1014 compresses a fluid chamber 1020. The fluid chamber 1020 is in fluid communication with the inlet of the pumps 408 and 410 via a pair of conduits 1022 and 1024, respectively. The spring 1018 is housed in a non-fluid filled cavity 1026 generally defined in the piston 1014. It is noted that the bottom end of the spring 1018 rests against a portion 1028 of the housing and that the piston 1014 is not resting against this portion 1028 but is lifted slightly above it when the accumulator 1010 is in its at rest full position. The portion 1028 of the housing includes a hole 1030 formed therein that is exposed to atmosphere. The spring 1018 preferably has a relatively low spring force and essentially only needs to overcome the seal friction to assist in moving the piston 1014 upwardly. The springs 540 of the fluid separators 520 and 522 preferably must generate enough force acting on the pistons 530 to cause the pressure within the chambers 536 to push back the piston 1014 of the low pressure accumulator 1010.

To perform an initial fill of the auxiliary brake module 1002, the front and rear fluid circuits of the brake system 1000 have preferably not been filled yet and are still dry. One of the first steps is to pull a vacuum from the chamber 1020, the conduits 1022 and 1024, as well as the conduits 412, 422, 430 and 438. This can be accomplished with the assistance of a conduit 1032 connected to either the conduit 1022 or the conduit 1024, such as is shown in FIG. 14. A manually operated bleed valve 1034 may be inserted into the conduit 1032 to assist in pulling the vacuum and filling the auxiliary brake module 1002 with brake fluid. It is preferable to maintain the piston 1014 in its position as shown in FIG. 15 such that the bottom of the piston 1014 does not rest on the bottom floor or portion 1028 of the housing but is spaced therefrom. This is preferred during the filling process such that a hydraulic lock of the piston 1014 does not occur within the low pressure accumulator 1010. Maintaining this spaced relationship can be accomplished by inserting a rod (not shown) through the hole 1030 to contact and engage with the bottom portion of the piston 1014. This will keep the piston 1014 from moving downwardly, as viewing FIG. 15. It is also preferable that the pistons 530 of the fluid separators 520 and 522 be maintained in a position to minimize their respective inlet chambers 536 during this brake fluid filling process. Again, a rod may be inserted within the fluid separators in a direction with the bias of the springs 540 to minimize the volume of the chambers 536. Fluid can then be introduced through the conduit 1032 to fill the auxiliary brake module 1002 while the rods are maintained in their positions to prevent movement of the pistons 530 and 1014. Once the auxiliary brake module is properly filled, the bleed valve 1034 can be turned off or otherwise shut. The rods can then be removed. Although the use of the rods assist in the filling procedure (as discussed above), the use of the rods could be eliminated if the exact or precise volume of fluid was known to completely fill the auxiliary brake module 1002. If this exact volume is reached when filling the auxiliary brake module 1002, then it is now known that the fill procedure was accurate.

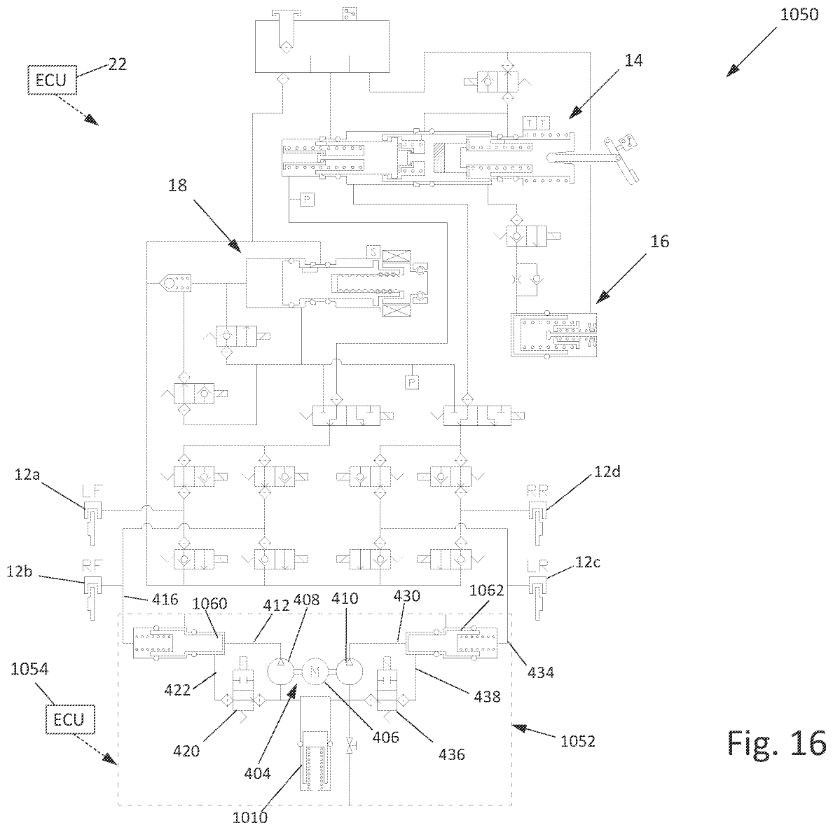

There is illustrated in FIG. 16 an alternate embodiment of brake system, indicated generally at 1000. The brake system 1050 is similar in function and structure as the brake system 1000. The brake system 1050 includes an auxiliary brake module 1052 similar in function as the auxiliary brake module 1002. A secondary ECU 1054 controls the auxiliary brake module 1052. One of the differences is that the auxiliary brake module 1052 of the brake system 1050 utilizes flow intensifiers 1060 and 1062 in place of fluid separators 520 and 522 as in the brake system 1000. The flow intensifiers 1060 and 1062 operate in a similar manner and have the same advantages as the flow intensifiers 910 and 912 of the brake system 900 described in detail above.

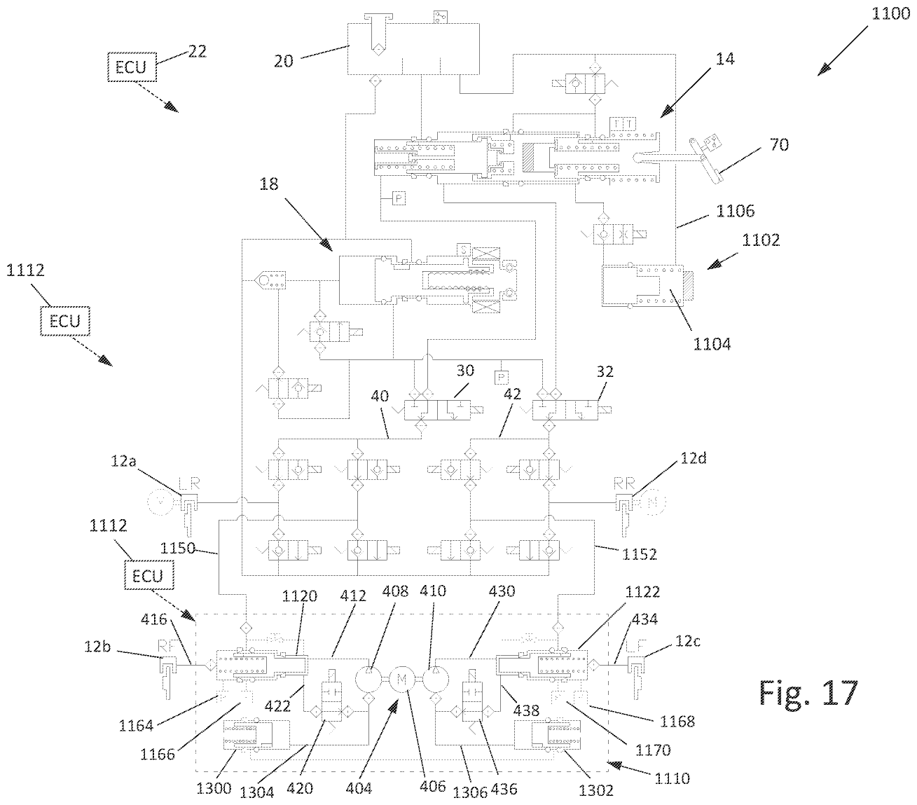

Referring now to FIG. 17, there is illustrated an alternate embodiment of a brake system, indicated generally at 1100, that is fairly similar in structure and function as the preceding brake systems described above. As such, similarities between the brake systems may not be discussed in duplication herein. In addition, similar structures and components of the brake system 1100 will use the same reference numbers as in the preceding brake systems. The brake system 1100 includes the three piston master cylinder 14, the plunger assembly 18, the reservoir 20, and the main ECU 22. The brake system 1100 utilizes a pedal simulator 1102 which is similar in design as the pedal simulator 650 of the brake system 600. However, the pedal simulator 1102 is of a “wet” design such that brake fluid is disposed in a spring chamber 1104 which is in fluid communication with the reservoir 20 via a conduit 1106

The brake system 1100 is a diagonally split system such that the wheel brake 12a is associated with the left rear wheel of the vehicle in which the brake system 1100 is installed. The wheel brake 12b is associated with the right front wheel. The wheel brake 12c is associated with the left front wheel. The wheel brake 12d is associated with the right rear wheel.

The brake system 1100 includes an auxiliary brake module, indicated generally at 1110. The auxiliary brake module 1110 functions as a second source of pressurized fluid, such as under certain failed conditions of the brake system 1100. As a secondary source of pressurized fluid, the auxiliary brake module 1110 provides an added volume of fluid to the brake system 1100 during a manual push through braking event. Additionally, the brake system 1100 could be controlled to provide autonomous braking such that the auxiliary control module 1110 is operated even if the driver is not pressing on the brake pedal 70. The auxiliary brake module 1100 may be housed in a different block or unit remotely located from the remainder of the brake system 1100, or may be housed integrally therewith. The auxiliary brake module 1110 may further include a secondary ECU 1112 (separate from the main ECU 22) for controlling the various valves and components of the secondary brake module 1110. The secondary ECU 1112 may also be in communication with the main ECU 22.

Similar to the brake system 1050, the auxiliary brake module 1110 of the brake system 1000 includes the pump assembly 404 having the motor 406 and first and second pumps 408 and 410. The auxiliary brake module 1110 also includes the pump valves 420 and 436, corresponding to the first and second pumps 408 and 410, respectively. The outlet of the pump 408 is in fluid communication with the conduit 412, while the inlet of the pump 408 is in fluid communication with the conduit 422 and the pump valve 420. The outlet of the pump 410 is in fluid communication with the conduit 430, while the inlet of the pump 410 is in fluid communication with the conduit 438 and the pump valve 436.

One of the differences of the auxiliary brake module 1110 compared to the auxiliary brake module 1052 is the use of differently configured flow intensifiers 1120 and 1122 compared to the flow intensifiers 1060 and 1062. The flow intensifiers 1120 and 1122 have a three seal design. The flow intensifiers 1120 and 1122 essentially perform the same function as the flow intensifiers 1060 and 1062 in that they isolate the fluid within the auxiliary brake module 1110 as well as provide a larger volume of fluid to the wheel brakes 12b and 12c. The flow intensifiers 1120 and 1122 are essentially identical in structure in function. Thus, only the structure and function of the flow intensifier 1120 will be discussed in detail with respect to FIG. 18 but it should be understood that the same description applies to the second flow intensifier 1122 as well.

As shown in an enlarged schematic view in FIG. 18, the flow intensifier 1120 includes a stepped piston 1130 disposed in a multi-stepped bore 1132 of a housing defining an inlet chamber 1134 and an outlet chamber 1136. A spring 1138 biases the piston 1130 within the housing towards the rightward direction, as viewing FIG. 18. The effective hydraulic areas acting on the chambers 1134 and 1136 are such that a greater amount of fluid will be displaced out through the conduit 416 (leading to the wheel brake 12b), than entering the inlet chamber 1134 via the conduit 412 from the first pump 408. The flow intensifier 1120 may be designed with any suitable ratio of volume entering versus exiting the flow intensifier 1120. For example, the flow intensifier 1120 could be configured such that for every 1.0 cm³ of fluid entering the inlet chamber 1134, 2.0 cm³ of fluid exits the outlet chamber 1136. A suitable pump structure for the pumps 408 and 410 are generally low flow but high pressure output style pumps due to the reduced flow requirements because of the addition of the flow intensifiers 1120 and 1122 into the brake system 1100.

The flow intensifier 1120 further includes a lip seal 1140 engaged with a larger diameter portion of the piston 1130. The flow intensifier 1120 includes a seal 1142 also engaged with the larger diameter portion of the piston 1130. A lip seal 1144 is engaged with the smaller diameter portion of the piston 1130. A passageway(s) 1146 is formed through the piston 1130. The passageway 1146 provides fluid communication between the second chamber 1136 and a conduit 1150 when the flow intensifier 1120 is in its rest position, as shown in FIGS. 17 and 18. In this position, the wheel brake 12b is in fluid communication with the isolation valve 30 via the conduit 1150. Thus, during normal braking, pressurized fluid from the conduit 40 is diverted to the wheel brake 12b. In a similar manner, the wheel brake 12c is in fluid communication with the conduit 42 via a conduit 1152 which permits passing of fluid through the second flow intensifier 1122.

As best shown in FIG. 18, the flow intensifier 1120 may further include an optional bleed screw 1160 mounted within a conduit 1162 to assist in the initial filling of fluid within the flow intensifier 1120 after manufacture and installation into the vehicle. The conduit 1162 is in fluid communication with the chamber 1134 and the conduit 1150. The second flow intensifier 1122 may have a similar bleed screw set up. The bleed screws 1160 may also help during any replacement of the brake fluid from the brake system(s).

As shown in FIGS. 17 and 18, optional first and second pressure sensors 1164 and 1166 may be installed into the auxiliary brake module 1110. The pressure sensor 1164 senses the pressure of the chamber 1136 representative of the pressure at the wheel brake 12b. The pressure sensor 1166 senses the pressure of the conduit 1150 which is representative of the pressure from the master cylinder 14 via the conduit 40 such as during a manual push through braking event. The pressure sensors 1164 and 1166 preferably send signals to the secondary ECU 1112 for controlling the auxiliary brake module 1110. The pressure sensors 1164 an 1166 may optionally also be connected to the main ECU 22 for controlling the brake system 10 under normal conditions. Alternatively, the auxiliary brake module 1110 may use information from the travel sensors 214 and/or 215 from the master cylinder 14 to indicate the driver's intent instead of using information from the pressure sensors 1164 and 1166. Similar to the pressure sensors 1164 and 1166, the auxiliary brake module 1110 may include pressure sensors 1168 and 1170 associated with the second flow intensifier 1122 and the wheel brake 12c.

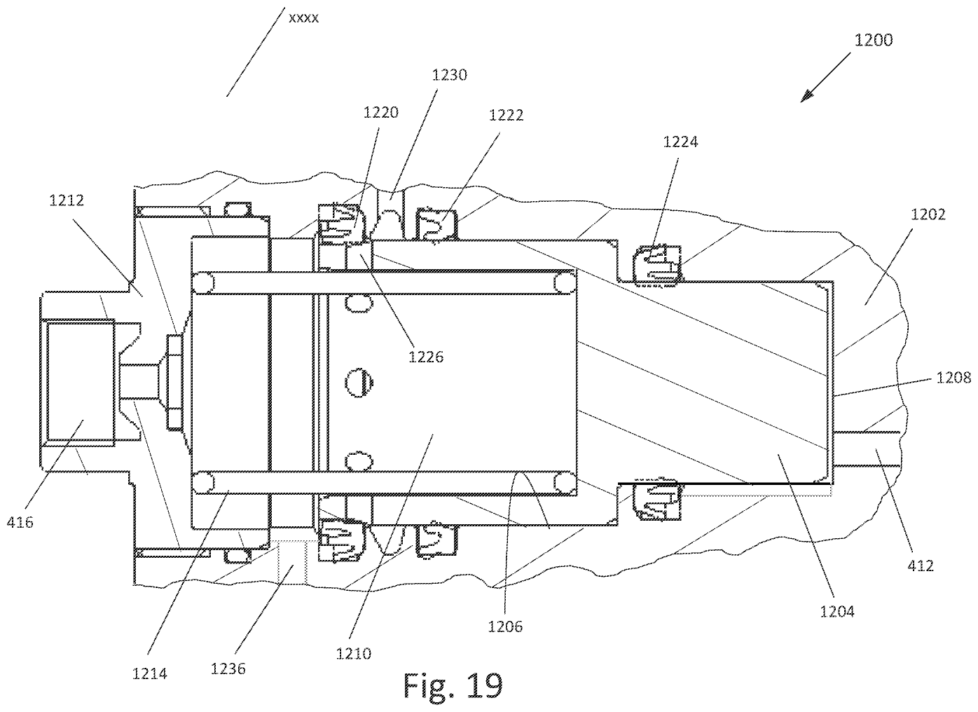

There is illustrated in FIG. 19 a more detailed illustration of a flow intensifier, indicated generally at 1200, which may be used for the flow intensifier 1122 in the brake system 1100, for example. The flow intensifier 1200 is mounted within a housing 1202, such as a metallic block or housing containing the components of the auxiliary brake module in which the flow intensifier 1200 is housed in. The flow intensifier 1200 includes a stepped piston 1204 disposed in a multi-stepped bore 1206 of a housing defining an inlet chamber 1208 and an outlet chamber 1210. Note that a retainer 1212 may be used to cap the end of the left-hand end of the bore 1206, as viewing FIG. 19, such that the retainer 1212 also helps seal the outlet chamber 1210. In the embodiment shown, the retainer 1212 is threadably engaged with internal threads formed at the end of the bore 1206. A spring 1214 biases the piston 1204 within the housing 1202 towards the rightward direction, as viewing FIG. 19. The effective hydraulic areas acting on the chambers 1208 and 1210 are such that a greater amount of fluid will be displaced out through the conduit 416 (through a hole of the retainer 1212 and leading to the wheel brake 12b), than entering the inlet chamber 1208 via the conduit 412 from the first pump 408. The flow intensifier 1200 may be designed with any suitable ratio of volume entering versus exiting the flow intensifier 1200.

The flow intensifier 1200 further includes a seal 1220 engaged with a larger diameter portion of the piston 1204. The flow intensifier 1120 includes a seal 1222 also engaged with the larger diameter portion of the piston 1204. A seal 1224 is engaged with the smaller diameter portion of the piston 1204. A passageway(s) 1226 is formed through the piston 1204. The passageway 1226 provides fluid communication between the second chamber 1210 and a conduit 1230 when the flow intensifier 1200 is in its rest position, as shown in FIG. 19. In this position, a wheel brake, such as the wheel brake 12b of the brake system 1100 of FIG. 17, is in fluid communication with the isolation valve 30 via the conduit 1230. Thus, during normal braking, pressurized fluid from the conduit 40 is diverted to the wheel brake 12b, for example. A conduit 1236 may be formed through the housing 1202 for connecting the second chamber 1210 with an optional pressure sensor, such as the pressure sensor 1164.

Another difference between the brake systems 1050 and 1100 is that the brake system 1100 utilizes a pair of low pressure accumulators 1300 and 1302 one for each of the pumps 408 and 410 instead of a single low pressure accumulator 1010 as in the brake system 1050. The accumulator 1300 provides fluid to the inlet of the pump 408 via a conduit 1304. The accumulator 1302 provides fluid to the inlet of the pump 410 via a conduit 1306. The accumulators 1300 and 1302 function in the same manner as the single low pressure accumulator 1010 to provide a source of fluid at a relatively low pressure, such as for example, less than 1 bar above atmospheric pressure to the inlet of the pumps 408 and 410. The low pressure accumulators 1300 and 1302 can have any suitable structure to accomplish this maximum braking event. The low pressure accumulators 1300 and 1302 may have a similar structure as the low pressure accumulator 1010 although sized smaller.

Although the use of a single low pressure accumulator, such as the accumulator 1010, as in the brake system 1050, may be more cost effective and/or simplistic than a pair of accumulators, utilizations of a pair of smaller accumulators 1300 and 1302 may have other advantages over a single unit. One of the advantages of having a pair of low pressure accumulators 1300 and 1302 is that there may be a packaging advantage in that a pair of smaller components may be easier to mount in a block or housing rather than one large and/or long component. Also, having two separate low pressure accumulators 1300 and 1302 may be advantageous under certain failsafe conditions such that if one of the accumulators fails or leaks, the other accumulator will be able to provide fluid to at least the other pump. Additionally, it may be easier to design a pair of smaller springs versus a higher load spring for a single accumulator.

There is illustrated in FIG. 20 a more detailed illustration of a low pressure accumulator, indicated generally at 1320 which may be used for the low pressure accumulators 1300 and 1302, for example. The low pressure accumulator 1320 is mounted within a housing 1322, such as a metallic block or housing containing the components of the auxiliary brake module in which the low pressure accumulator 1320 is housed in. The low pressure accumulator 1320 includes a bore 1324 formed in the housing 1322 of the low pressure accumulator 1320. A piston 1326 is slidably disposed in the bore 1324 and is sealingly engaged with an inner wall of the bore 1324 by a seal 1328. A spring 1330 biases the piston 1326 rightward, as viewing FIG. 20, such that rightward motion of the piston 1326 compresses a fluid chamber 1340. The fluid chamber 1340 is in fluid communication with the inlet of the pump 408, for example, via the conduit 1304. The spring 1330 is housed in a non-fluid filled cavity 1344 generally defined in the piston 1326. It is noted that the left-hand end of the spring 1330 rests against and is retained in by a retainer 1350. The retainer 1350 may be made of any suitable material, such as metal or plastic. The retainer 1350 may include flexible flanges 1352 with outwardly extending fingers 1356 to snap the retainer 1350 in place within a groove formed in the bore 1324. Of course, the retainer 1350 could be held in place by any suitable manner.

The low pressure accumulator 1320 may include optional features to assist in filling and/or bleeding the auxiliary brake module in which it is installed. For example, the low pressure accumulator 1320 may include a conduit 1360 which can be connected with a source of fluid during filling and/or bleeding of the system. Fluid from the conduit 1360 can flow past the seal 1328 during this process. An additional seal 1362 may be used to prevent this fluid from entering the cavity 1344.

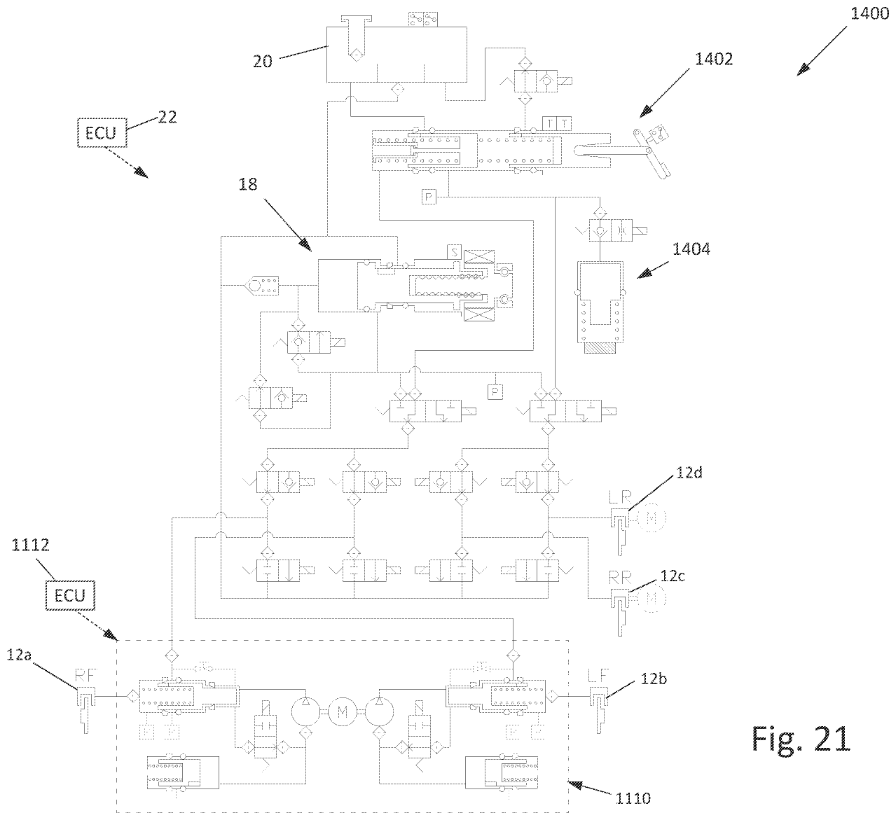

Referring now to FIG. 21, there is illustrated an alternate embodiment of a brake system, indicated generally at 1400, that is fairly similar in structure and function as the brake system 1100 described above. As such, similarities between the brake systems may not be discussed in duplication herein. In addition, similar structures and components of the brake system 1400 will use the same reference numbers as in the preceding brake systems. The brake system 1400 includes a two piston master cylinder 1402, similar to the two piston master cylinder 602 of the brake system 600. The brake system 1400 further includes the plunger assembly 18, the reservoir 20, the main ECU 22, and the auxiliary brake module 1110. The brake system 1400 utilizes a “dry” pedal simulator 1404.

The brake system 1400 is a vertically split system such that the wheel brake 12a is associated with the right front wheel of the vehicle in which the brake system 1400 is installed. The wheel brake 12b is associated with the left front wheel. The wheel brake 12c is associated with the right rear wheel. The wheel brake 12d is associated with the left rear wheel.

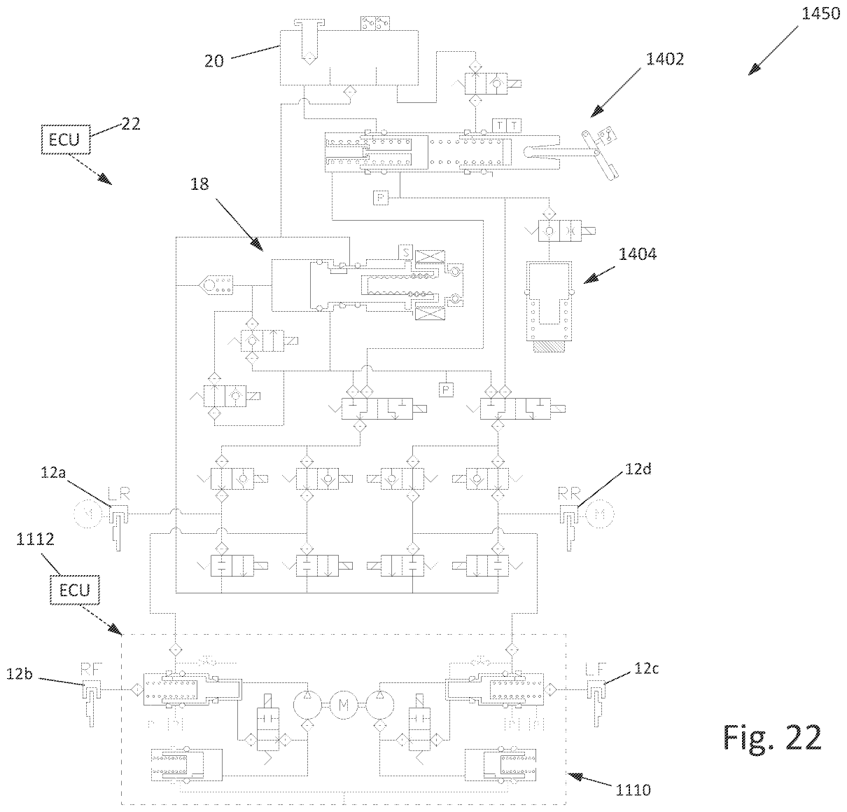

Referring now to FIG. 22, there is illustrated an alternate embodiment of a brake system, indicated generally at 1400, that is fairly similar in structure and function as the brake system 1100 described above. As such, similarities between the brake systems may not be discussed in duplication herein. In addition, similar structures and components of the brake system 1400 will use the same reference numbers as in the preceding brake systems. The brake system 1400 includes a two piston master cylinder 1402, similar to the two piston master cylinder 602 of the brake system 600. The brake system 1400 further includes the plunger assembly 18, the reservoir 20, the main ECU 22, and the auxiliary brake module 1110. The brake system 1400 utilizes a “dry” pedal simulator 1404.

The brake system 1400 is a vertically split system such that the wheel brake 12a is associated with the right front wheel of the vehicle in which the brake system 1400 is installed. The wheel brake 12b is associated with the left front wheel. The wheel brake 12c is associated with the right rear wheel. The wheel brake 12d is associated with the left rear wheel.

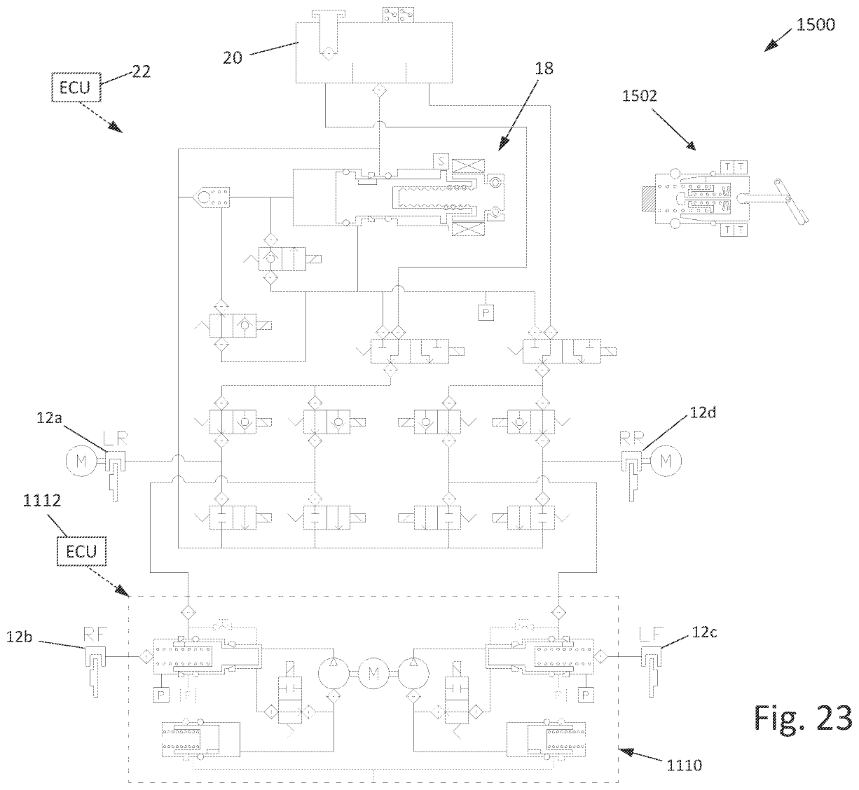

Referring now to FIG. 23, there is illustrated an alternate embodiment of a brake system, indicated generally at 1500, which could be configured as an autonomous brake system to eliminate the manually operated brake pedal, the master cylinder, and the pedal simulator. Alternatively, the brake system 1500 could be configured as a “brake-by-wire” system, similar to the brake system 850 described above such that the brake system 1500 does receive input from a driver of the vehicle via a remote pedal simulator, indicated generally at 1502.

The brake system 1500 is a diagonally split system such that the wheel brake 12a is associated with the left rear wheel of the vehicle in which the brake system 1500 is installed. The wheel brake 12b is associated with the right front wheel. The wheel brake 12c is associated with the left front wheel. The wheel brake 12d is associated with the right rear wheel.

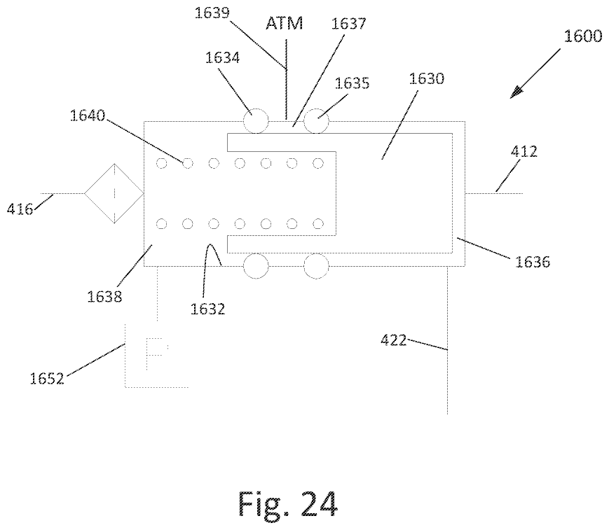

There is illustrated in FIG. 24 an enlarged schematic illustration of an alternate embodiment of a fluid separator, indicated generally at 1600. The fluid separator 1600 is similar in design as the fluid separators 520 and 674, and will be described as integrated with the brake system 500 of FIG. 4. One of differences is that the fluid separator 1600 has a dual seal design compared to a single seal design. However, the fluid separator 1600 is not designed to permit the passage of fluid between the seals as the fluid separator 674 is designed to. The fluid separator 1600 essentially performs the same function of the other fluid separators in that it isolates the fluid within its corresponding auxiliary brake module from the appropriate circuit.

As shown in FIG. 24, the fluid separator 1600 includes a cup shaped piston 1630 slidably disposed in a single diameter bore 1632 of a housing. A first seal 1634 is mounted in a groove formed in the housing and is sealingly engaged with the outer surface of the piston 1630 as the piston 1630 moves within the bore 1632. A second seal 1635 is mounted in a groove formed in the housing and is sealingly engaged with the outer surface of the piston 1630 as the piston 1630 moves within the bore 1632. Unlike the fluid separator 520, the fluid separator 1600 includes an air filled gap or cavity 1637 disposed between the seals 1634 and 1635 and between the outer cylindrical surface of the piston 1630 and the inner cylindrical surface of bore 1632. The cavity 1637 may be connected to an air filled duct or conduit 1639 that is preferably exposed to the atmosphere. The presence of air within the cavity 1637 helps prevent any undesirable fluid hydraulic lock that might otherwise occur if this cavity 1637 were filled with brake fluid.

The rest of the structure of the fluid separator 1600 is similar as the structure of the fluid separator 520. The right-hand end of the piston 1630, the seal 1634, and the bore 1632 define a first chamber 1636 which is in fluid communication with the conduit 412 leading to the outlet of the pump 408. The left-hand end of the piston 1630, the seal 1634, and the bore 1632 define a second chamber 1638 which is in fluid communication with the conduit 416 leading to the wheel brakes 12a and 12b. The piston 1630 is biased by a spring 1640 in a rightward direction, as viewing FIG. 24.

An advantage of the dual seal design of the fluid separator 1600 is that detection of proper sealing of the piston 1630 between the two chambers 1636 and 1638 within the fluid separator 1600 can be better detected than a single seal design. If one of the seals 1634 and 1635 is damaged and improperly seals with the piston 1630, this may be detectable as a system failure. Diagnostics could also be run to determine if a leakage occurs across the fluid separator 1600. For example, during a diagnostic mode, various valves within the main circuits could be closed to prevent fluid flow therein. The pumps 408 and 410 could then be run to determine if a pressure drop would occur indicating that one of the seals 1634 and/or 1635 is damaged and fluid is leaking past the damaged seal. In a single seal fluid separator, such a test would not cause a drop in pressure.

There is also shown in FIG. 24 an optional pressure transducer or pressure sensor 1652 which may be used in any of the above brake systems described herein. The pressure sensor 1652 senses the pressure of the fluid circuit associated with the wheel brakes. As described above, the secondary ECU can use sensor information, such as from the pressure sensor 1652, connected to the conduit 416 (and a corresponding pressure sensor connected to the conduit 434). The sensor 1652 aids in the use of closed loop pressure control by the secondary ECU. The pressure readings from the sensor 1652 are generally not used to determine the driver's intent.

With respect to the various valves of the brake system 10, the terms “operate” or “operating” (or “actuate”, “moving”, “positioning”) used herein (including the claims) may not necessarily refer to energizing the solenoid of the valve, but rather refers to placing or permitting the valve to be in a desired position or valve state. For example, a solenoid actuated normally open valve can be operated into an open position by simply permitting the valve to remain in its non-energized normally open state. Operating the normally open valve to a closed position may include energizing the solenoid to move internal structures of the valve to block or prevent the flow of fluid therethrough. Thus, the term “operating” should not be construed as meaning moving the valve to a different position nor should it mean to always energizing an associated solenoid of the valve.

The principle and mode of operation of the present disclosure has been explained and illustrated in its preferred embodiment. However, it must be understood that this disclosure may be practiced otherwise than as specifically explained and illustrated without departing from its spirit or scope.

1. A brake system having a wheel brake and being operable under a non-failure normal braking mode and a manual push-through mode, the system comprising:
a master cylinder operable by a brake pedal during a manual push-through mode to provide fluid flow at an output for actuating the wheel brake;
a first source of pressurized fluid providing fluid pressure for actuating the wheel brake under a normal braking mode; and
a second source of pressurized fluid for generating brake actuating pressure for actuating the wheel brake under the manual push-through mode.

2. The system of claim 1, wherein the second source of pressurized fluid includes a pump having an inlet supplied with fluid from a fluid source at low pressure.

3. The system of claim 2, wherein pressure from the fluid source is less than 1 bar above atmospheric pressure.

4. The system of claim 2, wherein the low pressure of the fluid within the fluid source is at about atmospheric pressure.

5. The system of claim 4, wherein the fluid source is a reservoir which additionally supplies fluid to the master cylinder.

6. The system of claim 2, wherein the fluid source is a low pressure accumulator including a spring biased piston pressurizing a chamber in fluid communication with the inlet of the pump.

7. The system of claim 6, wherein the second source of pressurized fluid includes a first low pressure accumulator supplying fluid to an inlet of a first pump, and a second low pressure accumulator supplying fluid to an inlet of a second pump.

8. The system of claim 1, wherein the system further includes a flow intensifier in fluid communication between the second source of pressurized fluid and the first wheel brake, wherein the flow intensifier increases a volume of fluid exiting the flow intensifier to the wheel brake compared to the volume of fluid entering the flow intensifier from the second source of pressurized fluid.

9. The system of claim 1, wherein the master cylinder includes a housing with first and second pistons slidably disposed in a bore formed in the housing, and wherein the first and second pistons are operable during a manual push-through mode such that the pair of pistons provide fluid flow at first and second outputs for actuating first and second wheel brakes, respectively.

10. The system of claim 1 further comprising:
a first electronic control unit for controlling the first source of pressurized fluid; and
a second electronic control unit, separate from the first electronic control unit, for controlling the second source of pressurized fluid.

11. The brake system of claim 1 further comprising:
a first travel sensor in communication with the first electronic control unit for sensing movement of a piston of the master cylinder; and
a second travel sensor in communication with the second electronic control unit for sensing movement of the piston of the master cylinder.

12. The system of claim 1, wherein the first source of pressurized fluid is a plunger assembly including a housing defining a bore therein, wherein the plunger assembly includes a piston slidably disposed in the bore of the plunger assembly such that movement of the piston pressurizes a pressure chamber when the piston is moved in a first direction, and wherein the pressure chamber of the plunger assembly is in fluid communication with an output, and wherein the plunger assembly further includes an electrically operated linear actuator for moving the piston within the bore.

13. The system of claim 12, wherein when the piston of the plunger assembly is operated in a second direction opposite the first direction, movement of the piston pressurizes a second pressure chamber which is in fluid communication with a second output.

14. The system of claim 1, wherein the master cylinder and the first source of pressurized fluid are housed in a first housing, and wherein the second source of pressurized fluid is housed in a second housing separate and remote from the first housing.

15. The system of claim 14, wherein the second source of pressurized fluid includes first and second pumps.

16. The system of claim 15, wherein a single hose connects inlets of the first and second pumps with the fluid reservoir.

17. The system of claim 15, wherein a first hose connects an inlet of the first pump with the fluid reservoir, and wherein a second hose separate from the first hose connects an inlet of the second pump with the fluid reservoir.

18. The system of claim 1 further including a fluid separator disposed between the wheel brake and the second source of pressurized fluid.
